(19) United States
(12) Patent Application Publication
(10) Pub. No.: US 2025/0351190 A1
(43) Pub. Date: Nov. 13, 2025

(54) ENHANCEMENTS FOR DIVERSITY SCHEMES FOR CONTENTION-BASED TRANSMISSION

(71) Applicant: QUALCOMM Incorporated, San Diego, CA (US)

(72) Inventors: Harikumar KRISHNAMURTHY, San Diego, CA (US); Ayan SENGUPTA, San Diego, CA (US); Alberto RICO ALVARINO, San Diego, CA (US); Syed Hashim Ali SHAH, San Diego, CA (US); Bharat SHRESTHA, San Diego, CA (US)

(21) Appl. No.: 19/169,266

(22) Filed: Apr. 3, 2025

Related U.S. Application Data
(60) Provisional application No. 63/644,908, filed on May 9, 2024.

(51) Int. Cl. H04W 74/0833; H04L 5/00; H04W 74/08

(52) U.S. Cl. CPC H04W 74/0833; H04L 5/0053; H04W 74/0866

(57) ABSTRACT

Methods, systems, and devices for wireless communications are described. A network may configure multiple transmission occasions (TOs) of a TO group such that the TOs do not occupy the same time resources (e.g., do not overlap in time). In some examples, the network may configure the TOs such that the TOs do not overlap in time with response windows for response messages. In some examples, a user equipment (UE) may not be expected to send transmissions (e.g., via TOs) and receive messages in the same time resources. In some examples, the UE may not send retransmissions for one access procedure if another access procedure has been resolved (e.g., if the UE has received a contention resolution indication corresponding to another TO in the group). Upon receiving a contention resolution indication, the UE may stop any other contention resolution timers, and send an acknowledgement message for the resolved access procedure.

### CROSS REFERENCES

The present application for patent claims benefit of U.S. Provisional Patent Application No. 63/644,908 by KRISHNAMURTHY et al., entitled “ENHANCEMENTS FOR DIVERSITY SCHEMES FOR CONTENTION-BASED TRANSMISSION,” filed May 9, 2024, assigned to the assignee hereof, and expressly incorporated herein.

### FIELD OF TECHNOLOGY

The following relates to wireless communications, including enhancements for diversity schemes for contention-based transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions, transmitting a first random access message via the first transmission occasion and using a first resource from a first set of resources of the first transmission occasion, transmitting a second random access message via the second transmission occasion and using a second resource from a second set of resources of the second transmission occasion, and monitoring for at least one of a first response message corresponding to the first random access message or a second response message corresponding to the second random access message.

A UE for wireless communications is described. The UE may include one or more memories storing processor executable code, and one or more processors coupled with the one or more memories. The one or more processors may individually or collectively be operable to execute the code to cause the UE to receive a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions, transmit a first random access message via the first transmission occasion and using a first resource from a first set of resources of the first transmission occasion, transmit a second random access message via the second transmission occasion and using a second resource from a second set of resources of the second transmission occasion, and monitor for at least one of a first response message corresponding to the first random access message or a second response message corresponding to the second random access message.

Another UE for wireless communications is described. The UE may include means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions, means for transmitting a first random access message via the first transmission occasion and using a first resource from a first set of resources of the first transmission occasion, means for transmitting a second random access message via the second transmission occasion and using a second resource from a second set of resources of the second transmission occasion, and means for monitoring for at least one of a first response message corresponding to the first random access message or a second response message corresponding to the second random access message.

A non-transitory computer-readable medium storing code for wireless communications is described. The code may include instructions executable by one or more processors to receive a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions, transmit a first random access message via the first transmission occasion and using a first resource from a first set of resources of the first transmission occasion, transmit a second random access message via the second transmission occasion and using a second resource from a second set of resources of the second transmission occasion, and monitor for at least one of a first response message corresponding to the first random access message or a second response message corresponding to the second random access message.

In some examples of the method, user equipment (UEs), and non-transitory computer-readable medium described herein, none of the more than one transmission occasion in the group of transmission occasions occupy the same time resources as any other transmission occasion in the group of transmission occasions.

Some examples of the method, user equipment (UEs), and non-transitory computer-readable medium described herein may further include operations, features, means, or instructions for selecting, from the group of transmission occasions, the first transmission occasion and the second transmission occasion based on the first transmission occasion occupying different resources in time than the second transmission occasion.

Some examples of the method, user equipment (UEs), and non-transitory computer-readable medium described herein may further include operations, features, means, or instructions for receiving at least one of the first response message and the second response message, where the first response message includes a first grant of resources for a first data message and the second response message includes a second grant of resources for a second data message, where the first grant of resources and the second grant of resources occupy different resources in time.

In some examples of the method, user equipment (UEs), and non-transitory computer-readable medium described herein, monitoring for at least one of the first response message and the second response message may include operations, features, means, or instructions for monitoring for the first response message during at least a portion of a first response window, and monitoring for the second response message during at least a portion of a second response window, where at least the portion of the first response window and at least the portion of the second response window occupy different resources in time.

A method for wireless communications by a UE is described. The method may include receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, transmitting a first random access message via the first transmission occasion and using a first resource from a first set of resources of the first transmission occasion, monitoring for a first response message via at least a first portion of a first response window corresponding to the first random access message and the first transmission occasion, and transmitting a second random access message via the second transmission occasion and using a second resource from a second set of resources of the second transmission occasion, where the second resource occupies different resources in time than at least the first portion of the first response window.

A UE for wireless communications is described. The UE may include one or more memories storing processor executable code, and one or more processors coupled with the one or more memories. The one or more processors may individually or collectively be operable to execute the code to cause the UE to receive a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, transmit a first random access message via the first transmission occasion and using a first resource from a first set of resources of the first transmission occasion, monitor for a first response message via at least a first portion of a first response window corresponding to the first random access message and the first transmission occasion, and transmit a second random access message via the second transmission occasion and using a second resource from a second set of resources of the second transmission occasion, where the second resource occupies different resources in time than at least the first portion of the first response window.

Another UE for wireless communications is described. The UE may include means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, means for transmitting a first random access message via the first transmission occasion and using a first resource from a first set of resources of the first transmission occasion, means for monitoring for a first response message via at least a first portion of a first response window corresponding to the first random access message and the first transmission occasion, and means for transmitting a second random access message via the second transmission occasion and using a second resource from a second set of resources of the second transmission occasion, where the second resource occupies different resources in time than at least the first portion of the first response window.

A non-transitory computer-readable medium storing code for wireless communications is described. The code may include instructions executable by one or more processors to receive a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, transmit a first random access message via the first transmission occasion and using a first resource from a first set of resources of the first transmission occasion, monitor for a first response message via at least a first portion of a first response window corresponding to the first random access message and the first transmission occasion, and transmit a second random access message via the second transmission occasion and using a second resource from a second set of resources of the second transmission occasion, where the second resource occupies different resources in time than at least the first portion of the first response window.

In some examples of the method, user equipment (UEs), and non-transitory computer-readable medium described herein, the first response window corresponding to the first random access message occupies different resources in time than the second transmission occasion according to the configuration of the group of transmission occasions.

In some examples of the method, user equipment (UEs), and non-transitory computer-readable medium described herein, a second portion of the first response window corresponding to the first random access message occupies different resources in time than at least a portion of the second transmission occasion according to the configuration of the group of transmission occasions.

Some examples of the method, user equipment (UEs), and non-transitory computer-readable medium described herein may further include operations, features, means, or instructions for receiving the first response message during the first portion of the first response window based on the monitoring, where transmission of the second random access message via the second transmission occasion occurs during the second portion of the first response window, and monitoring during the second portion of the first response window may be restricted.

Some examples of the method, user equipment (UEs), and non-transitory computer-readable medium described herein may further include operations, features, means, or instructions for receiving the first response message based on the monitoring, the first response message including a grant of a first set of resources for transmitting a first data message, where the first set of resources occupies different resources than any response windows corresponding to the more than one transmission occasion of the group of transmission occasions.

Some examples of the method, user equipment (UEs), and non-transitory computer-readable medium described herein may further include operations, features, means, or instructions for transmitting the first data message via the first set of resources according to the first response message and monitoring for a first contention resolution message corresponding to the first data message via a contention resolution window, where the first set of resources occupies different resources in time than any contention resolution windows associated with one or more additional transmission occasions of the more than one transmission occasion.

In some examples of the method, user equipment (UEs), and non-transitory computer-readable medium described herein, a set of multiple response windows corresponding to the more than one transmission occasion occupies different resources in time than any of the more than one transmission occasion.

In some examples of the method, user equipment (UEs), and non-transitory computer-readable medium described herein, a set of multiple contention resolution windows corresponding to the more than one transmission occasion occupy different resources in time than any of the more than one transmission occasion.

A method for wireless communications by a UE is described. The method may include receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, transmitting a first random access message via the first transmission occasion and using a first resource from a first set of resources of the first transmission occasion, transmitting a second random access message via the second transmission occasion and using a second resource from a second set of resources of the second transmission occasion, receiving at least a first response message during a first response window corresponding to the first transmission occasion, where the first response message includes a grant of a first set of resources for transmitting a first data transmission, receiving a second response message during a second response window corresponding to the second transmission occasion based on transmitting the second random access message, where the second response message includes a grant of a second set of resources for transmitting a second data transmission, transmitting a first data message via the first set of resources according to the first response message, transmitting a second data message via the second set of resources according to the second response message, and receiving a first contention resolution message corresponding to the first data message.

A UE for wireless communications is described. The UE may include one or more memories storing processor executable code, and one or more processors coupled with the one or more memories. The one or more processors may individually or collectively be operable to execute the code to cause the UE to receive a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, transmit a first random access message via the first transmission occasion and using a first resource from a first set of resources of the first transmission occasion, transmit a second random access message via the second transmission occasion and using a second resource from a second set of resources of the second transmission occasion, receive at least a first response message during a first response window corresponding to the first transmission occasion, where the first response message includes a grant of a first set of resources for transmitting a first data transmission, receive a second response message during a second response window corresponding to the second transmission occasion based on transmitting the second random access message, where the second response message includes a grant of a second set of resources for transmitting a second data transmission, transmit a first data message via the first set of resources according to the first response message, transmit a second data message via the second set of resources according to the second response message, and receive a first contention resolution message corresponding to the first data message.

Another UE for wireless communications is described. The UE may include means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, means for transmitting a first random access message via the first transmission occasion and using a first resource from a first set of resources of the first transmission occasion, means for transmitting a second random access message via the second transmission occasion and using a second resource from a second set of resources of the second transmission occasion, means for receiving at least a first response message during a first response window corresponding to the first transmission occasion, where the first response message includes a grant of a first set of resources for transmitting a first data transmission, means for receiving a second response message during a second response window corresponding to the second transmission occasion based on transmitting the second random access message, where the second response message includes a grant of a second set of resources for transmitting a second data transmission, means for transmitting a first data message via the first set of resources according to the first response message, means for transmitting a second data message via the second set of resources according to the second response message, and means for receiving a first contention resolution message corresponding to the first data message.

A non-transitory computer-readable medium storing code for wireless communications is described. The code may include instructions executable by one or more processors to receive a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, transmit a first random access message via the first transmission occasion and using a first resource from a first set of resources of the first transmission occasion, transmit a second random access message via the second transmission occasion and using a second resource from a second set of resources of the second transmission occasion, receive at least a first response message during a first response window corresponding to the first transmission occasion, where the first response message includes a grant of a first set of resources for transmitting a first data transmission, receive a second response message during a second response window corresponding to the second transmission occasion based on transmitting the second random access message, where the second response message includes a grant of a second set of resources for transmitting a second data transmission, transmit a first data message via the first set of resources according to the first response message, transmit a second data message via the second set of resources according to the second response message, and receive a first contention resolution message corresponding to the first data message.

Some examples of the method, user equipment (UEs), and non-transitory computer-readable medium described herein may further include operations, features, means, or instructions for receiving a request to send a retransmission of the second data message and refraining from sending the retransmission of the second data message based on receiving the first contention resolution message.

A method for wireless communications by a UE is described. The method may include receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions, transmitting a first instance of a random access message via the first transmission occasion and using a first resource from a first set of resources of the first transmission occasion, transmitting a second instance of the random access message via the second transmission occasion and using a second resource from a second set of resources of the second transmission occasion, and receiving at least a first response message during a first response window corresponding to the first transmission occasion, where the first response message includes a contention resolution indication corresponding to the first random access message.

A UE for wireless communications is described. The UE may include one or more memories storing processor executable code, and one or more processors coupled with the one or more memories. The one or more processors may individually or collectively be operable to execute the code to cause the UE to receive a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions, transmit a first instance of a random access message via the first transmission occasion and using a first resource from a first set of resources of the first transmission occasion, transmit a second instance of the random access message via the second transmission occasion and using a second resource from a second set of resources of the second transmission occasion, and receive at least a first response message during a first response window corresponding to the first transmission occasion, where the first response message includes a contention resolution indication corresponding to the first random access message.

Another UE for wireless communications is described. The UE may include means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions, means for transmitting a first instance of a random access message via the first transmission occasion and using a first resource from a first set of resources of the first transmission occasion, means for transmitting a second instance of the random access message via the second transmission occasion and using a second resource from a second set of resources of the second transmission occasion, and means for receiving at least a first response message during a first response window corresponding to the first transmission occasion, where the first response message includes a contention resolution indication corresponding to the first random access message.

A non-transitory computer-readable medium storing code for wireless communications is described. The code may include instructions executable by one or more processors to receive a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions, transmit a first instance of a random access message via the first transmission occasion and using a first resource from a first set of resources of the first transmission occasion, transmit a second instance of the random access message via the second transmission occasion and using a second resource from a second set of resources of the second transmission occasion, and receive at least a first response message during a first response window corresponding to the first transmission occasion, where the first response message includes a contention resolution indication corresponding to the first random access message.

Some examples of the method, user equipment (UEs), and non-transitory computer-readable medium described herein may further include operations, features, means, or instructions for receiving a request to send a retransmission of the second instance of the random access message and refraining from sending the retransmission of the second instance of the random access message based on receiving the first response message including the contention resolution indication.

A method for wireless communications by a UE is described. The method may include receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, transmitting a first random access message via the first transmission occasion and using a first resource from a first set of resources of the first transmission occasion and a second random access message via the second transmission occasion and using a second resource from a second set of resources of the second transmission occasion, and receiving at least one of a first response message including a first contention resolution indication during a first response window corresponding to the first transmission occasion, a second response message including a second contention resolution indication during a second response window corresponding to the second transmission occasion, a first contention resolution message including the first contention resolution indication, the first contention resolution message responsive to transmission of a first data message based on reception of the first response message, or a second contention resolution message including the second contention resolution indication, the second contention resolution message responsive to transmission of a second data message based on reception of the second response message, where the first response message or the first contention resolution message is associated with a first radio network temporary identifier (RNTI) and where the second response message or the second contention resolution message is associated with a second RNTI.

A UE for wireless communications is described. The UE may include one or more memories storing processor executable code, and one or more processors coupled with the one or more memories. The one or more processors may individually or collectively be operable to execute the code to cause the UE to receive a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, transmit a first random access message via the first transmission occasion and using a first resource from a first set of resources of the first transmission occasion and a second random access message via the second transmission occasion and using a second resource from a second set of resources of the second transmission occasion, and receive at least one of a first response message including a first contention resolution indication during a first response window corresponding to the first transmission occasion, a second response message including a second contention resolution indication during a second response window corresponding to the second transmission occasion, a first contention resolution message including the first contention resolution indication, the first contention resolution message responsive to transmission of a first data message based on reception of the first response message, or a second contention resolution message including the second contention resolution indication, the second contention resolution message responsive to transmission of a second data message based on reception of the second response message, where the first response message or the first contention resolution message is associated with a first radio network temporary identifier (RNTI) and where the second response message or the second contention resolution message is associated with a second RNTI.

Another UE for wireless communications is described. The UE may include means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, means for transmitting a first random access message via the first transmission occasion and using a first resource from a first set of resources of the first transmission occasion and a second random access message via the second transmission occasion and using a second resource from a second set of resources of the second transmission occasion, and means for receiving at least one of a first response message including a first contention resolution indication during a first response window corresponding to the first transmission occasion, a second response message including a second contention resolution indication during a second response window corresponding to the second transmission occasion, a first contention resolution message including the first contention resolution indication, the first contention resolution message responsive to transmission of a first data message based on reception of the first response message, or a second contention resolution message including the second contention resolution indication, the second contention resolution message responsive to transmission of a second data message based on reception of the second response message, where the first response message or the first contention resolution message is associated with a first radio network temporary identifier (RNTI) and where the second response message or the second contention resolution message is associated with a second RNTI.

A non-transitory computer-readable medium storing code for wireless communications is described. The code may include instructions executable by one or more processors to receive a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions, transmit a first random access message via the first transmission occasion and using a first resource from a first set of resources of the first transmission occasion and a second random access message via the second transmission occasion and using a second resource from a second set of resources of the second transmission occasion, and receive at least one of a first response message including a first contention resolution indication during a first response window corresponding to the first transmission occasion, a second response message including a second contention resolution indication during a second response window corresponding to the second transmission occasion, a first contention resolution message including the first contention resolution indication, the first contention resolution message responsive to transmission of a first data message based on reception of the first response message, or a second contention resolution message including the second contention resolution indication, the second contention resolution message responsive to transmission of a second data message based on reception of the second response message, where the first response message or the first contention resolution message is associated with a first radio network temporary identifier (RNTI) and where the second response message or the second contention resolution message is associated with a second RNTI.

Some examples of the method, user equipment (UEs), and non-transitory computer-readable medium described herein may further include operations, features, means, or instructions for transmitting an acknowledgement message corresponding to the first contention resolution indication.

Some examples of the method, user equipment (UEs), and non-transitory computer-readable medium described herein may further include operations, features, means, or instructions for obtaining a new C-RNTI indicated in the first contention resolution message or the first response message and performing wireless communications with a network entity according to the new C-RNTI.

Some examples of the method, user equipment (UEs), and non-transitory computer-readable medium described herein may further include operations, features, means, or instructions for promoting the first RNTI to a C-RNTI based on receiving the first contention resolution message or the first response message and performing wireless communications with a network entity according to the non-temporary C-RNTI.

In some examples of the method, user equipment (UEs), and non-transitory computer-readable medium described herein, the acknowledgement message includes an indication of one or more copies of the first random access message, one or more copies of the first data message, or a combination thereof, corresponding to one or more additional transmission occasions of the more than one transmission occasion of the group of transmission occasions.

In some examples of the method, user equipment (UEs), and non-transitory computer-readable medium described herein, the UE ceases monitoring for the second response message or monitoring for the second contention resolution message upon receiving the first response message or upon receiving the first contention resolution message.

Some examples of the method, user equipment (UEs), and non-transitory computer-readable medium described herein may further include operations, features, means, or instructions for receiving the first contention resolution indication, receiving the second contention resolution indication, selecting the first contention resolution indication, and transmitting a first acknowledgement message corresponding to the first contention resolution indication based on the selecting.

Some examples of the method, user equipment (UEs), and non-transitory computer-readable medium described herein may further include operations, features, means, or instructions for refraining from transmitting a second acknowledgement message corresponding to the second contention resolution indication based on the selecting.

In some examples of the method, user equipment (UEs), and non-transitory computer-readable medium described herein, the selecting includes a random selection of the first contention resolution indication from a set of multiple contention resolution.

Some examples of the method, user equipment (UEs), and non-transitory computer-readable medium described herein may further include operations, features, means, or instructions for selecting the first contention resolution indication may be based on the first RNTI having a lower value than the second RNTI, a timing of the first data message and the second data message, an order in time of the more than one transmission occasion of the group of transmission occasions, a preconfigured rule, one or more index values corresponding to the more than one transmission occasion, an instruction from a network entity, or any combination thereof.

Some examples of the method, user equipment (UEs), and non-transitory computer-readable medium described herein may further include operations, features, means, or instructions for selecting a first new C-RNTI indicated in the first contention resolution message or the first response message based on selecting the first contention resolution indication, where the second contention resolution message or the second response message indicates a second new C-RNTI, updating the first RNTI to a first new C-RNTI indicated in the first contention resolution message or the first response message, and communicating with a network entity according to a first updated C-RNTI, where the first contention resolution message or the first response message includes the first updated C-RNTI, and the second contention resolution message or the second response message includes a second updated C-RNTI.

Some examples of the method, user equipment (UEs), and non-transitory computer-readable medium described herein may further include operations, features, means, or instructions for promoting the first RNTI to a non-temporary C-RNTI based on the selecting and performing wireless communications with a network entity according to the non-temporary C-RNTI.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports enhancements for diversity schemes for contention-based transmission in accordance with one or more aspects of the present disclosure.

FIG. 2 shows an example of a wireless communications system that supports enhancements for diversity schemes for contention-based transmission in accordance with one or more aspects of the present disclosure.

FIG. 3 shows an example of a transmission occasion (TO) group that supports enhancements for diversity schemes for contention-based transmission in accordance with one or more aspects of the present disclosure.

FIG. 4 shows an example of a TO grouping scheme that supports enhancements for diversity schemes for contention-based transmission in accordance with one or more aspects of the present disclosure.

FIG. 5 shows examples of timelines that supports enhancements for diversity schemes for contention-based transmission in accordance with one or more aspects of the present disclosure.

FIG. 6 shows an example of a timeline that supports enhancements for diversity schemes for contention-based transmission in accordance with one or more aspects of the present disclosure.

FIG. 7 shows an example of a process flow that supports enhancements for diversity schemes for contention-based transmission in accordance with one or more aspects of the present disclosure.

FIG. 8 shows an example of a process flow that supports enhancements for diversity schemes for contention-based transmission in accordance with one or more aspects of the present disclosure.

FIG. 9 shows an example of a process flow that supports enhancements for diversity schemes for contention-based transmission in accordance with one or more aspects of the present disclosure.

FIG. 10 shows an example of a process flow that supports enhancements for diversity schemes for contention-based transmission in accordance with one or more aspects of the present disclosure.

FIGS. 11 and 12 show block diagrams of devices that support enhancements for diversity schemes for contention-based transmission in accordance with one or more aspects of the present disclosure.

FIG. 13 shows a block diagram of a communications manager that supports enhancements for diversity schemes for contention-based transmission in accordance with one or more aspects of the present disclosure.

FIG. 14 shows a diagram of a system including a device that supports enhancements for diversity schemes for contention-based transmission in accordance with one or more aspects of the present disclosure.

FIGS. 15 through 19 show flowcharts illustrating methods that support enhancements for diversity schemes for contention-based transmission in accordance with one or more aspects of the present disclosure.

### DETAILED DESCRIPTION

Wireless networks may configure physical random-access channel (PRACH) resources during a random-access channel (RACH) occasion (e.g., a transmission occasion for a RACH preamble or data transmission) for a user equipment (UE) to initiate a RACH procedure or to perform a RACH-less early data transmission (EDT) using the PRACH resources in the RACH occasion. The PRACH resources are generally shared resources that are available to any UE that determines to initiate the RACH procedure or to send the EDT to the network. For example, each UE may randomly select one of the PRACH resources (e.g., preambles) to send an access signal to the network according to the PRACH configuration. However, in some examples multiple UE may select the same resource and transmit access signals to the network during the RACH occasion. This may result in a collision of the access signal transmissions, which may introduce delays and disrupt communications between the UE and the network.

Accordingly, the described techniques provide for multiple transmission occasions (TOs) to be configured for UE(s), with each UE transmitting one or more data or access signals to the network using resources from one or more of the TOs in the group. For example, a UE may receive or otherwise obtain a configuration for a group of TOs. The group of TOs may include multiple TOs (e.g., more than one TO). Each TO in the group may be associated with or otherwise have a set of resources that are shared by multiple UEs for contention-based access signal transmissions. The UE may perform at least one data or access signal transmission in at least one TO in the group of TOs using a resource from the set of resources of the at least one TO. The UE may monitor for at least one response message based at least in part on the at least one data or access signal transmission.

The network may configure the TOs of the TO group such that the TOs do not occupy the same time resources (e.g., do not overlap in time). In some examples, the network may configure the TOs such that the TOs do not overlap in time with response windows for response messages. In some examples, the UE may not be expected to send transmissions (e.g., via TOs) and receive messages in the same time resources. In some examples, the UE may not send retransmissions for one access procedure (e.g., corresponding to a first TO of the TO group) if another access procedure has been resolved (e.g., if the UE has received a contention resolution indication corresponding to another TO in the group). Upon receiving a contention resolution indication, the UE may stop any other contention resolution timers, and send an acknowledgement message for the resolved access procedure.

Aspects of the disclosure are initially described in the context of wireless communications systems. Aspects of the disclosure are further illustrated by and described with reference to wireless communications systems, TO groups, TO grouping schemes, timelines, and process flows. Aspects of the disclosure are further illustrated by and described with reference to apparatus diagrams, system diagrams, and flowcharts that relate to enhancements for diversity schemes for contention-based transmission.

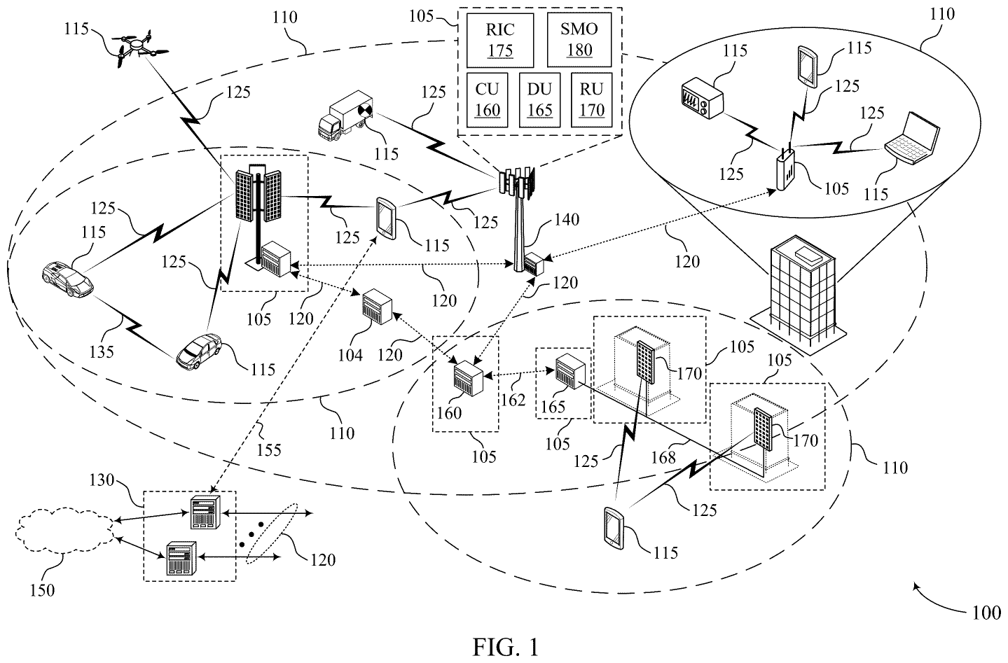

FIG. 1 shows an example of a wireless communications system 100 that supports enhancements for diversity schemes for contention-based transmission in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHZ)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogenous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

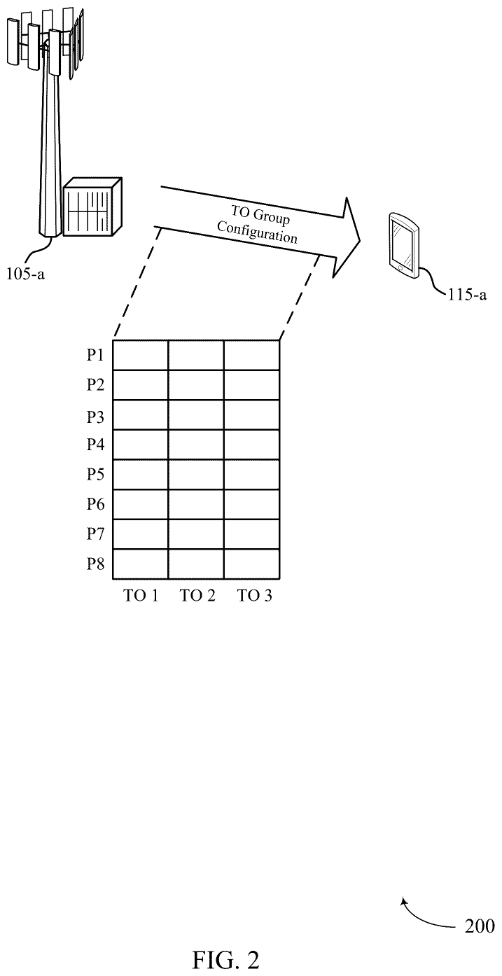

FIG. 2 shows an example of a wireless communications system 200 that supports enhancements for diversity schemes for contention-based transmission in accordance with one or more aspects of the present disclosure. Wireless communications system 200 may implement aspects of wireless communications system 100. Wireless communications system 200 may include a UE 115-a and a network entity 105-a, which may be examples of the corresponding devices described herein.

Wireless networks may utilize various access schemes to establish a connection between UE and the network. The access schemes may be contention-based or non-contention-based. The non-contention-based access schemes may include dedicated resources being configured for a UE to establish a connection to the network. The contention-based access schemes may include a pool of resources being established that are shared by all UE. Techniques described herein (e.g., with reference to contention-based schemes) may also apply to non-contention-based schemes (e.g., RACH-less schemes).

In some examples, a contention-based access scheme may include a four-step RACH procedure. The four-step RACH procedure may be initiated with a UE transmitting a message one (Msg 1) RACH preamble to the network entity. For example, after choosing a RACH occasion the UE may uniformly and randomly choose a RACH preamble from a set of allowed RACH preambles. The UE may transmit the RACH preamble to the network that is scrambled with a random-access radio network temporary identifier (RA-RNTI). The UE may then wait for a response message (e.g., a random-access response (RAR)) message from the network. In some aspects, the Msg 1 transmission may carry or otherwise convey an indication of a random-access preamble identifier (RAPID) associated with the RACH process.

The network may respond to the Msg 1 transmission by transmitting the response message (e.g., in a message two (Msg 2)). For example, upon correctly receiving the preamble from the UE the network entity may respond with the RAPID as well as including other information for a message three (Msg 3) transmission, such as a timing advance, uplink grant, and temporary cell radio network temporary identifier (C-RNTI). Or the network entity may respond with a backoff indication to let the UE know to abandon the current RACH procedure (e.g., in the situation where the network entity is busy).

The UE may respond to the Msg 2 transmission from the network entity by transmitting the Msg 3. For example, if the response message from the network entity includes the RAPID transmitted in the Msg 1, the UE may transmit the Msg 3 according to the uplink grant indicted in the Msg 2. In some aspects, the Msg 3 may be scrambled using the RNTI (e.g., a temporary C-RNTI) and include a contention resolution identifier/C-RNTI (e.g., if the network entity has already assigned a permanent C-RNTI to the UE).

The network entity may correctly receive the Msg 3 and resolve contention, if any. The network entity may transmit a response (e.g., a message four (Msg 4)) to the UE that includes the contention resolution identifier/C-RNTI of the successful UE. In some aspects, the network entity may also issue a retransmission of the Msg 3 if required. Upon receiving the Msg 4 with the matching contention resolution identifier it transmitted in Msg 3, the UE may consider the contention resolution and the random-access procedure successful. The UE may then promote the RNTI (e.g., the temporary C-RNTI) to the permanent C-RNTI (e.g., if not assigned earlier). In some aspects, the UE may transmit an acknowledgement of the Msg 4 to the network entity.

However, the contention-based RACH resources are shared by multiple UE, which may result in a collision. For example, Table 1 below shown an example of the contention resources that may be configured according to the traditional four-step RACH procedure. In this example, eight preamble resources (P1-P8) are configured for contention-based RACH procedures that are shared by multiple UE. In the example shown in Table 1, a first UE (e.g., UE1) may randomly select a sixth RACH preamble (P6) to transmit its Msg 1, a second UE (e.g., UE2) and a fourth UE (e.g., UE4) may randomly select a seventh RACH preamble (P7) to transmit their Msg 1, and a third UE (e.g., UE3) may randomly select a first RACH preamble (P1) to transmit its Msg 1.

TABLE 1

| | |
|---|---|
| P1 | UE3 |
| P2 | |
| P3 | |
| P4 | |
| P5 | |
| P6 | UE1 |
| P7 | UE2, UE4 |
| P8 | |

Accordingly, Table 1 shows an example where two (or more, in some examples) UE choose the same RACH preamble (e.g., P7, in this example) to transmit their Msg 1. For example, both the second UE and the fourth UE transmit identical Msg 1 to the network entity. In some examples, the network entity may not be able to correctly receive either Msg 1 due to the collision. In other examples, one UE may be associated with a better performing wireless channel such that the network entity is able to receive one Msg 1 but not the other Msg 1. In this example, the network entity may respond with the Msg 2 with the uplink grant information. In this scenario, both UEs would transmit Msg 3 in the same uplink grant, each with their own unique contention resolution identifiers. However, the network entity may not be able to decode both Msg 3. Again, in some examples the network entity may not be able to decode either Msg 3 due to the collision. However, in other examples the network entity may be able to correctly receive the Msg 3 from a UE having a better performing wireless channel (e.g., a much larger SINR). In this scenario, initiating a Msg 3 retransmission is unhelpful as it would not be UE-specific and, instead, be RNTI-specific (e.g., temporary C-RNTI-specific). So, but UEs would retransmit the Msg 3, which would not lead to contention resolution. In the situation where the UE does not receive Msg 4 with its identifier withing a stipulated window, the UE may need to retry the RACH procedure with the network entity.

Thus, in the example shown in Table 1 the network entity may transmit the response message with the uplink grant information for the RAPID corresponding to P1, P6, and P7. Each UE may respond with a Msg 3 transmission. The network entity may successfully decode the Msg 3 from UE1 and UE3 and send their Msg 4 with their contention resolution identifiers. However, the Msg 3 from UE2 and UE4 will either be undecodable (e.g., due to the collision) or one UE (e.g., the UE with the stronger SINR) out of UE2 or UE4 will be successful and the Msg 4 will address that UE's contention resolution identifier.

Another contention-based RACH procedure may include a two-step RACH procedure where Msg 1 and Msg 3 are combined into a message A (Msg A) and Msg 2 and Msg 4 are combined into a message B (Msg B). This approach may reduce the latency associated with RACH procedure. However, and similar to the four-step RACH procedure, if two or more UEs choose the same preamble they would be involved in a contention and at most one of those UEs would successfully receive a Msg B.

One variation of the two-step RACH procedure may include a RACH-less early data transmission (EDT) (e.g., being used in NB-IoT communications over a non-terrestrial network (NNT)). In RACH-less EDT, the UE may directly transmit data in the first transmission (e.g., without preamble) by choosing the data resources (as opposed to preambles too) from a pool of data resources for contention-based transmission. The UE may wait for a response message to the data transmission within a time window. Such a response message may include an indication of a successful contention resolution. This technique may be feasible in NTNs when the UE are GNSS-capable and have location information of the UE and the satellite (e.g., from the satellite ephemeris). However, even in this situation the collision discussed above may be applicable. That is, if two or more UEs choose the same data resource (e.g., corresponding to the preamble resource discussed above) for transmission of the RACH-less EDT, there will likely be a collision at the network entity and the RA procedure will fail (e.g., the RACH-less EDT transmission will fail). Thus, as described herein, a response message may refer to a msg 2 in a four step RA procedure, or a response message in a RACH-less EDT, among other examples.

For example and continuing with the example shown in Table 1, the network entity may send a response (e.g., the Msg B or an acknowledgment to the RACH-less EDT) corresponding to the data resources (e.g., which would be designated D1, D6, and D7 corresponding to P1, P6, and P7 from Table 1) with unique contention resolution identifiers for UE1 and UE3. However, for the data resource D7, the network entity cannot detect (e.g., absent a large difference in SINR between UE2 and UE4)) the transmission. Accordingly, the network entity may not be able to detect the unique contention resolution identifier from either UE2 or UE4. For both UE2 and UE4, the contention resolution will fail and each UE would need to restart the RACH procedure after waiting for the response window time. However, NTNs are generally associated with a large round-trip time (RTT) or round-trip delay (RTD). In this aspect, the response time window for Msg 2, Msg 4, Msg B, or a response to RACH-less EDT is generally quite large. This may result in large delays when the UE is not successful in completing the RACH procedure on the first try (e.g., such as in the case of a collision, as discussed above). Accordingly, it would be beneficial to reduce the probability of collisions to reduce the probability of failure of the RACH procedure and, therefore, the large delays that a collision entails (e.g., such as in an NTN).

In some wireless networks, the default scheme for random-access in a slotted ALOHA method. In this method, the wireless channel may be divided into small, fixed-length time slots or blocks of time and the UE are only allowed to transmit data at the beginning of each time slot or time block. For example, each UE may pick a preamble (or a data resource for RACH-less EDT) from a set of preambles (or a pool of data resources) uniformly and randomly. However, if more than one UE picks the same preamble (or data resources), there is a collision at that preamble (or data resource) and all UEs transmitting that preamble (or on that data resource) fail the random-access/data transmission. For example, each UE will either collide in the Msg 3 transmission (for preamble-based four-step RACH) or will not receive a contention resolution success indication (e.g., an acknowledgement) in response to the preamble or the data (e.g., in RACH-less EDT) transmission.

Accordingly, aspects of the techniques described herein provide for a diversity slotted ALOHA (DSA) approach to minimize the chances of collisions between multiple UE. Generally, this may include grouping TOs together where each UE may transmit at least one or more than one access signal (e.g., Msg 1, Msg 3, with or without a corresponding Msg 1, Msg A, or data in RACH-less EDT) to the network entity. For example, and as is shown in FIG. 2. this may include a group of TOs having three TOs (e.g., TO 1, TO 2, and TO 3), in this example. Generally, each TO may include a time slot or block of time during which any UE may transmit the data or access signals to the network entity. Each TO may include a single time slot or time block during which the access signal transmissions may occur or may include multiple time slots or time blocks (e.g., for repetition-based access signal transmissions). Each time slot or time block may span one or more symbols, one or more slots, or one or more radio frames.

This may include the network configuring the UE 115-a with the group of TOs. For example, the network entity 105-a may transmit or otherwise provide (and the UE 115-a may receive or otherwise obtain) a configuration for a group of TOs that include more than one TO (e.g., three TOs, in this example). In some examples, the configuration may be for multiple groups of TOs. For example, each group of TOs may have similar TOs (e.g., the same number and configuration of TOs) or may have different TOs (e.g., a different number or configuration of TOs). In some aspects, the UE 115-a may receive or otherwise obtain the configuration for the group(s) of TOs via a system information block (SIB) or via RRC signaling from the network entity 105-a.

Each TO in the group of TOs may include a set of resources shared by multiple UEs for contention-based data or access signal transmissions. In this example, the set of resources available during each TO includes eight RACH preamble resources (P1-P8). However, in the example where the data or access signal transmissions are for RACH-less EDT, the set of resources may include data resources (e.g., D1-D8). Generally, each resource in the set of resources may include time resources, frequency resources, spatial resources, or code resources that are to be used by UE selecting that resource for data or access signal transmission to the network entity 105-a.

In this example, the group of TOs may include N TOs (e.g., N=3 in this example) that make up the TO group. Each TO may generally include a set of resources (e.g., preamble resources, such as P1-P8, or data resources, such as in RACH-less EDT) that are shared by multiple UEs for contention-based data or access signal transmissions. In some aspects, the group of TOs may be formed based on or otherwise associated with a coverage enhancement level associated with the UE, a number of repetitions to be used for transmission in a TO, or a transport block size (TBS) metric associate with at least one data or access signal transmission from the UE. The coverage enhancement level associated with a UE may be dependent on or based on, for example, a received downlink signal quality at the UE. This may be determined based on a reference signal receive power (RSRP) level or a reference signal received quality (RSRQ) level. This may be expressed in terms of the number of repetitions that are configured for transmission (e.g., UEs with a poorer RSRP may select resources from a coverage enhancement level pool which is configured with a larger number of repetitions, than would a UE with a higher RSRP value). In some aspects, this may include one group of TOs being configured at the UE for a first coverage enhancement level and a different group of TOs being configured for UE with a second (e.g., different) coverage enhancement level (e.g., multiple groups of TOs).

With regards to the TBS, if the UE wants to use or is configured to use a low TBS, it may pick a resource (e.g., TO) from a resource pool (e.g., from a group of TOs or from a different group of TOs) with fewer repetitions. For a transmission with a larger TBS, the UE may select a resource from a resource pool with a larger number of repetitions.

Accordingly, this may include the UE being provided through SIB or other signaling, the grouping of TOs into TO groups within which a UE performs burst transmissions. The configuration can be specified per coverage enhancement level or per TBS. The group(s) of TOs may be contiguous or noncontiguous and may be disjointed or have at least partial overlap across groups.

In some aspects, this may include the UE 115-a receiving or otherwise obtaining (and the network entity 105-a transmitting or otherwise outputting) an indication of a burst size associated with the group of TOs. The burst size may identify a quantity of TOs in the group of TOs during which the UE 115-a is to perform data or access signal transmission. For example, a burst size (e.g., k) may also be configured that generally defines the number of TO(s) in the group(s) of TOs during which the UE are to perform access signal transmissions. In some examples, the burst size is set to two (e.g., k=2) such that each UE is expected to perform two data or access signal transmissions during two TOs in the group of TOs. Accordingly, each UE may choose two out of the three TOs in the group and choose a preamble resource (e.g., P1-P8, in this example) or a data resource (e.g., D1-D8 in RACH-less EDT) in each TO for the data or access signal transmission. Each UE may independently and randomly select the preamble resource or data resource from more than one TO in the group of TOs. That is, in each of the k TOs the UE would pick a resource from the available resources independently and randomly to use to transmit the at least one data or access signal transmission.

Aspects of the described techniques may also provide for an irregular repetition slotted ALOHA (e.g., IRSA) approach. In this approach, the UE 115-a may choose a burs size k from an available list of burst sizes (e.g., according to a burst size probability). For example, the network entity 105-a may transmit or otherwise output (and the UE 115-a may receive or otherwise obtain) an indication of a set of burst sizes associated with the group(s) of TOs. Each burst size (e.g., k) in the set of burst sizes may identify the number of TO(s) in the group(s) of TOs during which the UE is to perform a data or access signal transmission. The UE 115-a, in this example, may select a burst size from the set of burst sizes. The quantity of data or access signal transmission may be performed during the corresponding TOs according to the burst size. That is, if the UE 115-a chooses a burst size of two (e.g., k=2), the quantity of data or access signal transmissions may be two transmissions performed during two TOs. In another example where the UE 115-a chooses a burst size of six (e.g., k=6), the UE 115-a may perform six data or access signal transmissions during six TOs from the group of TOs. Accordingly, N TOs may be grouped into a TO group and the UE 115-a may choose k of the N TOs in the group to transmit data or access signal transmissions. In each of these k TOs, the UE 115-a may select or otherwise choose a resource (e.g., any of P1-P8, or D1-D8 for RACH-less EDT) from the available resources independently and randomly (e.g., according to a random selection scheme) and performs the data or access signal transmission in or using the selected resource.

In some aspects, the set of burst sizes may include different burst sizes for different UEs (e.g., a subset of UEs in the multiple UEs). For example, the configuration for the set of burst sizes may be specified per-coverage enhancement level or per TBS associated with each UE. In some aspects, the set of burst sizes may be specified as common for all TO groups or may be specified for each TO group separately or specified commonly for sets of TO groups. That is, the set of burst sizes may include a common burst size for all TOs in the group of TOs, as a unique burst size for each TO in the group of TOs, or as a same burst size for multiple groups of TOs. That is, the set of burst sizes associated with a first group of TOs may be different from a set of burst sizes associate with a second group of TOs.

In some aspects, this may include the UE 115-a selecting or otherwise picking the TO (e.g., uniformly at random) after selecting a burst size. In some examples, the UE 115-a may include the exact TO(s) to transmit in (e.g., if k=2 and N=6, then UE 115-a may randomly pick TO 1 and TO 4) independently and uniformly at random. The exact resource within a TO (e.g., if there are 48 resources l in a TO) may be selected by the UE 115-a randomly (e.g., the UE 115-a may randomly select resources number 17 from the 48 resources in the TO). This approach may be applied for both the DSA approach or the IRSA approach discussed above (e.g., the UE 115-a selects the TO(s) randomly and then randomly selects a resource from the TO to transmit the data or access signal transmission).

Accordingly, in some aspects the burst size may be provided as a single entry (e.g., the same burst sizes for all UEs), such as according to the DSA approach discussed above, or may be a list of burst sizes from which the UE samples the burst size for the current TO group, such as according to the IRSA approach discussed above. Each burst size may correspond to an integer that is equal to or larger than one. In some aspects, the UE may be configured or otherwise provided with the burst size configuration through SIB or other signaling.

In some aspects, a bursting size probability may be associated with the burst size. For example, the network entity 105-a may transmit or otherwise output (and the UE 115-a may receive or otherwise obtain) an indication of burst size probabilities associated with the set of burst sizes. The UE 115-a may choose or otherwise select the burst size from the set of burst sizes according to the burst size probability. For example, the UE 115-a may be configured or otherwise provided (e.g., via SSB signaling or other signaling means) with the indication of the probabilities with which the burst size for the current group of TOs is sampled from the burst size list (e.g., as previously indicated). The configuration for the burst size probabilities may be specified per coverage enhancement level of the UE or per TBS of the associated data or access signal transmission(s). For example, an optional field containing a list of a same length as the set of burst sizes whose entries are in the interval [0,1] and add up to one.

In some examples, the group of TOs may include eight TOs (e.g., N=8) and the burst size set (e.g., the set of burst sizes) associated with the group of TOS are configured as [1,2,4,6]. The burst size probabilities for the corresponding burst sizes in this example may be configured as [0.5,0.25,0.125,0.125]. The UE 115-a may choose a burst size of TO 1 using a weighting point of 0.5, of TO 2 using a weighting point 0.25, of TO 4 using a weighting point of 0.125, or of TO 4 using a weighting point of 0.125. That is, the UE 115-a may select from the set of burst sizes according to the burst size probabilities indicated to the UE 115-a for the group of TOs. In the example where the burst size probabilities are not specified for the UE 115-a, the UE 115-a may select a burst size from the set of burst sizes according to a (pre) defined distribution, such as a discrete uniform distribution.

Accordingly, the UE 115-a may perform at least one data or access signal transmission in at least one TO in the group of TOs. For example, the UE 115-a may use a resource from the set of resources of the at least one TO. More particularly, the UE 115-a may be configured with N TOs in the group of TOs, select the burst size k indicating how many TOs in the group of TOs the UE 115-a will use, and then select a resource l from each of the k TOs to use to perform the data or access signal transmissions. In some aspects, the UE 115-a may perform these selections randomly (e.g., according to a random selection scheme).

In some aspects, the at least one data or access signal transmission may also be referred to as a burst. For example, the burst may include multiple copies of the same information conveyed in each data or access signal transmission from the UE 115-a. Examples of the types of messages may be conveyed in the at least one data or access signal transmission include, but are not limited to, a RACH preamble transmission, a RACH Msg A, a RACH-less EDT, a RACH Msg 3 transmission (e.g., with or without a corresponding RACH Msg 1 transmission) or a contention-based preconfigured uplink resources (PUR) data transmission.

In some aspects, the described techniques may further provide for contention resolution DSA (e.g., CRDSA). For example, the burst size may be fixed (e.g., according to DSA) or the UE 115-a may select the burst size from the set of burst sizes (e.g., IRSA), such as according to the probability distribution when configured.

In some examples, as described herein, N transmission occasions (TOs) are grouped into a TO group and the UE 115-a may choose k of the TOs to transmit in (e.g., where k<N). In each of the k selected occasions, the UE may pick a resource from l available resources (e.g., within the selected TO) independently or randomly, and may transmit RA signaling via the selected resources. A UE may successfully complete RA procedures if at least one resource pair, transmission pair, or TO in which the UE transmits a RA message or data message does not collide with a transmission by another UE. This approach may enable the network entity 105-a, upon successfully decoding at least one copy of a transmission by the UE 115-a (e.g., a data or access signal transmission in one TO), to remove interference from the other copies in the burst to enable decoding of other UEs whose transmissions have collided in those resources and TO pair. This interference cancellation followed by decoding may be repeated multiple times by the network entity 105-a.

For example, the UE 115-a may include or otherwise convey a first information in a first data or access transmission during a first TO. The first information may carry or otherwise convey information that identifies a second data or access signal transmission that was performed during a second TO. In some examples, the UE 115-a may include or otherwise convey a second information in the second data or access transmission during the second TO. The second information, in this example, may carry or otherwise convey information that identifies the first data or access signal transmission that was performed during the first TO. That is, to easily and effectively perform interference cancellation, the network entity 105-a may know the location or contents of the other data or access signal transmissions within the burst for a corresponding UE. The data or preamble carried by each copy within a burst from the same UE may be the same. That is, the at least one data or access signal transmission during k TOs of the group of N TOs may be copies of each other in each TO (e.g., the same information is transmitted in each TO from a UE). The UE 115-a may communicate (e.g., within one or each copy) the location of the other copies within the burst. In some aspects, this information may be communicated in a MAC-CE or in an RRC message. In some aspects, this information may be embedded in the transmission using a last of the {TO, resource} pair of each copy of the burst in a predefined order or can be a reference to a row in a lookup table or can be a list of RNTIs (e.g., a list of temporary C-RNTIs).

That is, the first information or the second information may include at least one of an ordered pair of the at least one TO and resource index for the resource (e.g., I) from the set of resources associated with the at least one TO, an index that is associated with an ordered pair, or a RNTI (e.g., the TC-RNTI) associated with the ordered pair. The ordered pair may generally refer to the k TO from the group of TOs that the UE 115-a has used to transmit a data or access signal transmission and an index to the resource from the set of resources associated with that TO.

The UE 115-a may then monitor for at least one response message based on the at least one data or access signal transmission. In some aspects, the response from the network entity 105-a may be a separate response for each TO or may be a combined response for a group of TOs. Which option to choose may be configured or otherwise indicated to the UE 115-a via SIB or other signaling means (e.g., in RRC signaling).

For example, in some aspects the UE 115-a may monitor for multiple response messages associated with multiple data or access signal transmission during a corresponding multiple TOs. Each response message, in this example, may correspond to a data or access signal transmission perform during a corresponding TO. In some aspects, each response message in multiple response messages may be associated with a response window or a response timer associated with the corresponding TO (e.g., per-TO response windows or response timers). That is, the UE may continue to monitor for a response for each TO it has transmitted in (e.g., within a TO group) using separate response windows or response timers for each of the TOs. In another example, a combined response message may be used by the network entity 105-a. For example, the UE 115-a may monitor for a common response message associated with multiple data or access signal transmissions in the group of TOs. In this example, the common response message may be associated with a response window or a response timer associated with the group of TOs (e.g., per-TO group response window or response timer).

In some aspects, the success of the at least one data or access signal transmission may be based on at least one resource (e.g., TO and resource pair) in which the UE 115-a transmits not colliding with a transmission from another UE. However, if the UE 115-a does not receive or otherwise obtain a response for any of the transmissions in a burst, the UE 115-a may be configured to declare a failure and retry the transmission procedure or continue with an updated set of transmission parameters (e.g., a fewer number of transmissions in the burst). For example, the UE 115-a may identify or otherwise determine that the at least one response message was not received during a response window or response timer. Accordingly, the UE 115-a may identify or otherwise determine that the at least one data or access signal transmission to be a failure based on the at least one response message not being received.

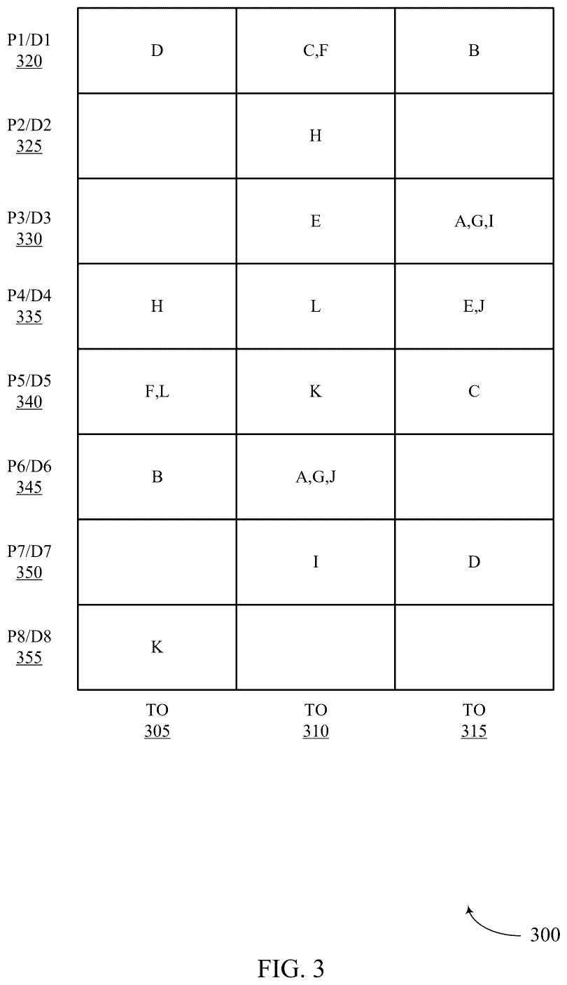

FIG. 3 shows an example of a TO group 300 that supports enhancements for diversity schemes for contention-based transmission in accordance with one or more aspects of the present disclosure. The TO group 300 may implement aspects of wireless communications system 100 or wireless communications system 200. Aspects of TO group 300 may be implemented at or implemented by a UE or a network entity, which may be examples of the corresponding devices described herein.

As discussed above, aspects of the describe techniques may include grouping multiple (e.g., more than one) TOs into a group of TOs. For example, a UE may receive a configuration for a group of TOs where each TO in the group of TOs includes a set of resources that are shared by multiple UEs for contention-based data or access signal transmissions. The UE may perform at least one data or access signal transmission in at least one TO in the group of TOs using a resource from the set of resources of the at least one TO. The UE may monitor for at least one response message based on the at least one data or access signal transmission.

In some examples, as shown in FIG. 3, the group of TOs includes three TOs (e.g., a first TO 305, a second TO 310, and a third TO 315). However, it is to be understood that the group of TOs may include more than three TOs or may include fewer than three TOs (e.g., two TOs). Further, each TO in the group of TOs has an associated set of resources. In such examples, the set of resources for each TO includes eight resources. For example, each TO in the group of TOs is associated with a first preamble or data resource 320, a second preamble or data resource 325, a third preamble or data resource 330, a fourth preamble or data resource 335, a fifth preamble or data resource 340, a sixth preamble or data resource 345, a seventh preamble or data resource 350, and an eighth preamble or data resource 355. That is, each resource in set of resources may correspond to a preamble resource (e.g., for use during a RACH procedure) or a data resource (e.g., for use during RACH-less EDT).

In the non-liming example shown in FIG. 3, twelve UEs (e.g., UE-A through UE-L) use the group of TOs to perform at least one data or access signal transmission. In this example, each of the twelve UEs selects a burst size of two such that each UE performs a burst during two of the three TOs in the group of TOs. For example and during the first TO 305, a UE-D selects the first preamble or data resource 320, the UE-H selects the fourth preamble or data resource 335, both UE-F and UE-L select the fifth preamble or data resource 340, the UE-B selects the sixth preamble or data resource 345, and the UE-K selects the eighth preamble or data resource 355 to perform their respective data or access signal transmission. During the second TO 310, both UE-C and UE-F select the first preamble or data resource 320, the UE-H selects the second preamble or data resource 325, the UE-E selects the third preamble or data resource 330, the UE-L selects the fourth preamble or data resource 335, the UE-K selects the fifth preamble or data resource 340, each of the UE-A, UE-G, and UE-J select the sixth preamble or data resource 345, and the UE-I selects the seventh preamble or data resource 350 to perform their respective data or access signal transmission. During the third TO 315, the UE-B selects the first TO 305, each of the UE-A, UE-G, and UE-I select the third preamble or data resource 330, both of the UE-E and UE-J select the fourth preamble or data resource 335, the UE-C selects the fifth preamble or data resource 340, and the UE-D selects the seventh preamble or data resource 350 to perform their respective data or access signal transmission. As noted, in this example each UE has selected a burst size of two (e.g., k=2) such that each UE performs a data or access signal transmission during two TOs in the group of TOs.

As can be seen, this results in collisions occurring between some of the UEs. For example, UE-F and UE-L have colliding transmissions during the first TO 305 using the fifth preamble or data resource 340. UE-C and UE-F have colliding transmissions during the second TO 310 using the first preamble or data resource 320 and UE-A, UE-G, and UE-J have colliding transmissions using the sixth preamble or data resource 345. Similarly, UE-A, UE-G, and UE-I have colliding transmissions during the third TO 315 using the third preamble or data resource 330 and UE-E and UE-J have colliding transmissions using the fourth preamble or data resource 335.

In some examples, UEs having a successful data or access signal transmission may include UE-B, UE-C, UE-D, UE-E, UE-H, UE-I, UE-K and UE-L since each UE has at least one non-colliding transmission out of the two transmissions within the group of TOs. For example, although each of the UE-C, UE-E, UE-I, and UE-L have one colliding transmission, each UE has also selected a resource within at least one TO to perform its data or access signal transmission during at least one TO in the group of TOs. For example, the UE-L has a colliding transmission during the first TO 305 but does not have a colliding transmission during the second TO 310. Similarly, the UE-C has a colliding transmission during the second TO 310 but its transmission during the third TO 315 does not collide with any other UE transmission(s). Accordingly, each UE in this example may have a successful data or access signal transmission using the techniques described herein. That is, the chance of the data or access signal transmission being successful is increased using the TO grouping techniques describe herein.

Furthermore, in some aspects, some or all of the UEs using the group of TOs may indicate first information and, in some example, the second information in each data or access signal transmission that points to the other transmission. In this example, the network entity may use interference cancellation to achieve greater success in successfully decoding the colliding data or access signal transmissions. For example, using interference cancellation based on the first and second information may result in UE-F and UE-L having successful data or access signal transmissions. For example, the network entity may use interference cancellation to remove the interference from UE-L during the first TO 305 to recover the transmission from UE-F. Similarly, the network entity may use interference cancellation to remove the interference from UE-E during the third TO 315 to recover the transmission from UE-J. Accordingly, the successful UEs after one-step interference cancellation may now include the UE-B, UE-C, UE-D, UE-E-, UE-F, UE-H, UE-I, UE-J, UE-K, and UE-L.

Each of UE-A and UE-G may have unsuccessful data or access signal transmissions due to both transmission from these UEs colliding with multiple UEs.

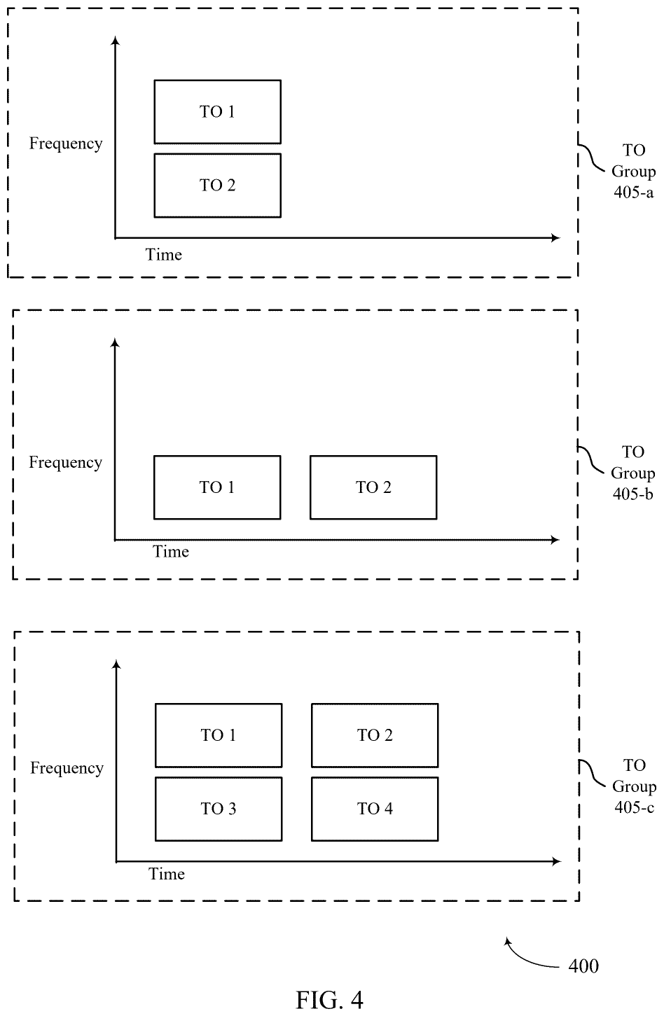

Some UEs may not be able to support simultaneous transmission, or may be half duplex UEs (e.g., or UEs operating in a half-duplex mode). If TOs within a TO group 300 overlap in time (e.g., as described in greater detail with reference to FIG. 4), then a UE that does not support simultaneous transmissions may not be able to transmit RA signals (e.g., msg 1) via multiple TOs. For example, a UE may not support simultaneous msg 3 transmission if preambles and resources chosen by the UE overlap in time. Similarly, if no restrictions are placed on grants of resources for data transmissions in a RA procedure (e.g., grants of resources for msg 3), then the grants of resources may overlap, and a UE that does not support simultaneous transmissions may not be able to transmit RA signals or data signals (e.g., msg 3) via multiple overlapping grants of resources. According to techniques described herein, the network may help to ensure that the uplink grants for transmission by a same UE are non-overlapping in time. In some examples, as described herein, the network entity may not be aware of which RAPID corresponds to the same UE. To address such a lack of knowledge, the network may help to ensure that the uplink grants for different TOs in a same TO group are non-overlapping in time (e.g., as described in greater detail with reference to FIG. 4). Uplink grants for different preambles or resources within a TO may be overlapping in time, but the UE may only select a preamble or resources for each TO (e.g., that is not overlapping in time).

Additionally, or alternatively, a half-duplex UE may be unable to transmit a RA message via a TO and receive a response message at the same time, or may be unable to transmit a msg 1 or msg 3 and receive a contention resolution message at the same time, or may be unable to transmit a first message in a RACH-less procedure and monitor for a response message including a contention resolution indication at the same time. Additionally, or alternatively, a UE may expend unnecessary resources and power receiving multiple contention resolution messages and transmitting multiple acknowledgement messages when a single resolved RA procedure is sufficient to complete a contention-based or contention-free access procedure. Techniques described herein provide techniques for increasing the likelihood or helping to ensure that such scenarios are avoided, including restrictions on transmission or monitoring, scheduling and configuration of non-overlapping resources, scheduling of TOs or selection of TOs to improve the likelihood of successfully access procedures via non-overlapping TOs, and procedures for selecting one successfully resolved access procedure upon receiving a contention resolution message (e.g., msg 4 in a four-step procedure or a response message in a RACH-less procedure) and terminating other pending access procedures, etc.

FIG. 4 shows an example of a TO grouping scheme 400 that supports enhancements for diversity schemes for contention-based transmission in accordance with one or more aspects of the present disclosure. The TO grouping scheme 400 may implement, or be implemented by, aspects of the wireless communications system 100, the wireless communications system 200, or the TO group 300. For example, one or more UEs (e.g., UEs 115) and one or more network entities (e.g., network entities 105), which may be examples of corresponding devices described with reference to FIGS. 1-3, may communicate via one or more TO groups 405.

In each TO group 405, TOs may be grouped together. In some examples, ROs may be multiplexed in time, frequency, or both. If TOs are grouped together, the UE could be expected to transmit multiple data or access signal transmission (e.g., Msg 1 or a first transmission in a RACH-less EDT procedure) at the same time. However, if the UE does not support multiple transmission simultaneously, then the UE may not be able to perform diversity based schemes described herein with such a grouping. For instance, the network entity may configure the UE with a TO group 405-a, including multiple TOs (e.g., TO 1 and TO 2). The TO 1 and the TO 2 may overlap with each other in time. As described herein, the multiple TOs may support multiple transmissions of a RA message or data message, increasing the likelihood of successful access procedures. However, if the UE does not support simultaneous transmissions in time, then the UE may not be able to make use of techniques described herein, and may only be able to transmit via one TO.

In some examples, the UE may not be expected to perform multiple transmissions simultaneously (e.g., multiple msg 1 transmissions, a msg 1 transmission and a msg 3 transmission, or multiple msg 3 transmissions, or multiple data transmissions, among other examples). The network entity may schedule or configure resources for the TOs of a given TO group 405 to avoid simultaneous transmission by the UE, or the UE may select TOs or resources within TOs to avoid simultaneous transmission (e.g., of msg 1).

In some examples, the UE may expect TOs within a TO group 405 to be non-overlapping in time. The network entity may refrain from configuring a TO group 405 with TOs that overlap in time (e.g., may refrain from scheduling TOs within a TO group that overlap in time). For example, the network entity may configure the TO group 405-b. The TO group 405-b may include the TO 1 and the TO 2, which do not overlap in time.

In some examples, the UE may help to ensure that its choice of k transmissions within a TO group 405 are non-overlapping in time. The network entity may help to ensure that at least a subset of TOs within a TO group 405 do not overlap in time (e.g., that at least a quantity of TOs within a TO group 405 equal to or greater than the value of k do not overlap in time). For example, the network entity may configure the TO group 405-c. The TO group 405-c may include multiple TOs (e.g., the TO 1, the TO 2, the TO 3, and the TO 4). At least a subset of the TOs in the TO group 405-c (e.g., 2 TOs, for k=2) may not overlap in time. The UE may then select TOs rom the TO group that do not overlap in time. For instance, the UE may select the TO 1 and the TO 2 that do not overlap in time, or the TO 3 and the TO 4 that do not overlap in time, and may transmit RA messages (e.g., msg 1) via the select subset of TOs (e.g., the TO 1 and the TO 2, or the TO 3 and the TO 4). However, the UE may refrain from selecting TOs within the TO group 405-c that do overlap in time (e.g., the UE may not select the TO 1 and the TO 3). Techniques described herein may apply to two-step RACH, RACH-less, or four-step RACH procedures, among other examples. For instance, the UE may transmit msg A of a two-step RACH procedure via the TOs in a TO group 405 as described herein, and the network may configure the TO groups 405 accordingly. In some examples, the UE may support transmission with TOs that at least partially overlap in time, but may transmit RA messages via non-overlapping portions of partially overlapping TOs (e.g., such that the transmissions themselves do not overlap), or may select resources within the overlapping TOs such that the selected resources from two overlapping TOs do not overlap with each other in time.

In some examples (e.g., in the case of four-step RACH), the UE may perform preamble or resource selection for step-1 (e.g., for msg 1 transmitted via a TO in a TO group 405), and the UE may then transmit a msg 3 for each successful msg 1. For instance, the UE may transmit two instances of a RA messages (e.g., msg 1) via a first TO and a second TO (e.g., TO 1 and TO 2 in TO group 405-b, or TO 1 and TO 2 in TO group 405-c). The UE may then monitor for (e.g., and in some cases receive) a response message during a response window for each of the two RA messages. The two response messages may grant resources for two data messages (e.g., msg 3 on PUSCH), and the UE may transmit two data messages (e.g., msg 3) via the granted resources. The UE may expect non-overlapping in time msg 3 grants corresponding to non-overlapping msg 1 transmissions belonging to the same TO group 405. For instance, the network entity may refrain from granting resources for a first msg 3 (e.g., corresponding to the TO 1) that overlap with a grant of resources for a second msg 3 (e.g., corresponding to the TO 2 in the same TO group 405).

In some examples, downlink reception windows for different TOs in a TO group 405 may overlap. However, the UE may not be able to receive multiple messages multiplexed over different frequencies but overlapping in time. IN such examples (e.g., for NR systems, NR devices, or UEs supporting an NR radio access technology (RAT), it may be possible to multiplex multiple PDSCH transmission across frequency at the same time. The UE may not be expected to receive overlapping downlink response messages corresponding to transitions in a same TO group. For example, the network may schedule TOs, TO groups, corresponding response windows for response message transmissions (e.g., for each TO in a TO group), data messages (e.g., msg 3), contention resolution windows, contention messages (e.g., msg 4), or any combination thereof to avoid the scenario in which the UE is expected to receive overlapping downlink response messages (e.g., msg 2 or msg 4) corresponding transmissions in the same TO group 405. That is, the network entity may refrain from scheduling response windows that overlap (e.g., or may refrain from scheduling or configuring TOs in resources that result in corresponding response window overlap), or may refrain from scheduling contention resolution windows that overlap (e.g., or may refrain from granting resources for msg 3 resulting in corresponding contention resolution window overlap). In some examples, the network entity may support scheduling of response windows or contention resolution windows that overlap, but may select resources within the overlapping response windows for multiple non-overlapping msg 2 transmissions, or may select resources within overlapping contention resolution windows for multiple non-overlapping msg 4 transmissions.

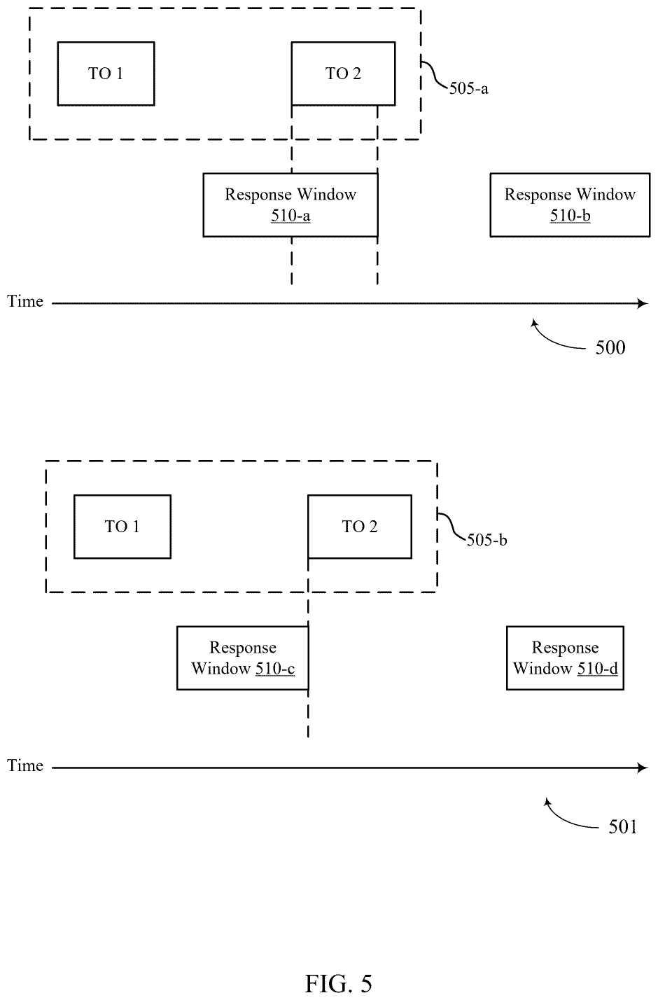

In some examples, as described in greater detail with reference to FIG. 5, the network entity may apply one or more restrictions to avoid overlap between uplink and downlink transmissions during RA procedures for half duplex UEs.

FIG. 5 shows an example of a timeline 500 that supports enhancements for diversity schemes for contention-based transmission in accordance with one or more aspects of the present disclosure. The timeline 500 and the timeline 501 may implement, or may be implemented by, aspects of the wireless communications system 100, the wireless communications system 200, the TO group 300, or the TO grouping scheme 400. For example, one or more UEs (e.g., UEs 115) and one or more network entities (e.g., network entities 105), which may be examples of corresponding devices described with reference to FIGS. 1-4, may communicate according to the timeline 500 or the timeline 501.

Some wireless devices (e.g., half duplex UEs, or a UE operating in a half-duplex mode) may not support reception and transmission at the same time (e.g., which the UE may report via capability information). The network entity may help to ensure, according to techniques described herein, that the UE is not required to monitor for downlink signaling when performing an uplink transmission, and vice versa (e.g., during a RACH procedure). Such restrictions may be particularly important, as described herein, when the network entity is responding to the UE on a per TO basis (e.g., the network entity receives multiple RA messages, such as msg 1 or msg A, from one or more UEs via multiple TOs in a TO group, as described in greater detail with reference to FIGS. 2-4). For example, as TOs within a TO group may not be contiguous in time, it is possible that uplink transmissions for one TO may overlap with downlink reception windows (e.g., response windows) of a different TO in the same TO group for the same UE. The network entity may schedule such windows (e.g., a response window, or a contention resolution window) to avoid overlapping of such windows with TOs. In some examples, the response windows or contention resolution windows may partially overlap with a TO, but the network entity may help to ensure that a reception time of the transmitted message (e.g., msg 2, msg B, or msg 4) does not overlap in time with transmission timing (e.g., at the UE) during the TO (e.g., the resources of the reception time of the response message, the contention resolution window, etc. are different than the resources of the TOs of a TO group). As described herein, resources that do not overlap are different resources (e.g., a first set of resources that does not overlap with a second set of resources in time refers to a first set of resources in time that is different from a second set of resources in time).

For example, the network may configure the TOs of a TO group 505-a, as illustrated with reference to the timeline 500. The TO group 505-a may include multiple TOs (e.g., the TO 1 and the TO 2). Each TO may correspond to a response window for receiving a response message (e.g., a response window 510 for receiving msg 2 or msg B responsive to transmitting a msg 1 via a corresponding TO). For instance, the TO 1 may correspond to the response window 510-a, and the TO 2 may correspond to the response window 510-b. The UE may transmit a first RA message (e.g., msg 1 or msg A) via the TO 1, and may monitor for a corresponding response message (e.g., msg 2 or msg B) during the response window 510-a. Similarly, the UE may transmit a second RA message (e.g., msg 1 or msg A) via the TO 2, and may monitor for a corresponding response message (e.g., msg 2 or msg B) during the response window 510-b.

However, a portion of the response window 510-a may overlap with the TO 2. In such examples, the network entity may help to ensure that transmission of the response message occurs prior to a transmission time corresponding to the TO 2. That is, if the network entity successfully receives the RA message via the TO 1, then the network entity may transmit a response message during a first portion of the response window 510-a (e.g., prior to the transmission timing at the UE for the TO 2). The UE may cease monitoring for the first response message during the second portion of the response window 510-a, and may instead transmit the second RA message via the TO 2.

In some examples, the network may configure the TOs of a TO group 505-b, as illustrated with reference to the timeline 500. The TO group 505-b may include multiple TOs (e.g., the TO 1 and the TO 2). Each TO may correspond to a response window for receiving a response message (e.g., a response window 510 for receiving msg 2 or msg B responsive to transmitting a msg 1 via a corresponding TO). For instance, the TO 1 may correspond to the response window 510-c, and the TO 2 may correspond to the response window 510-d. The UE may transmit a first RA message (e.g., msg 1 or msg A) via the TO 1, and may monitor for a corresponding response message (e.g., msg 2 or msg B) during the response window 510-c. Similarly, the UE may transmit a second RA message (e.g., msg 1 or msg A) via the TO 2, and may monitor for a corresponding response message (e.g., msg 2 or msg B) during the response window 510-c. The network may schedule the TOs of the TO group 505-b, or may schedule the response windows 510, or both, such that the response windows 510 do not overlap with the TOs of the TO group 505-b. For instance, the network may help to ensure that the response window 510-c does not overlap with the TO 2 of the TO group 505-b.

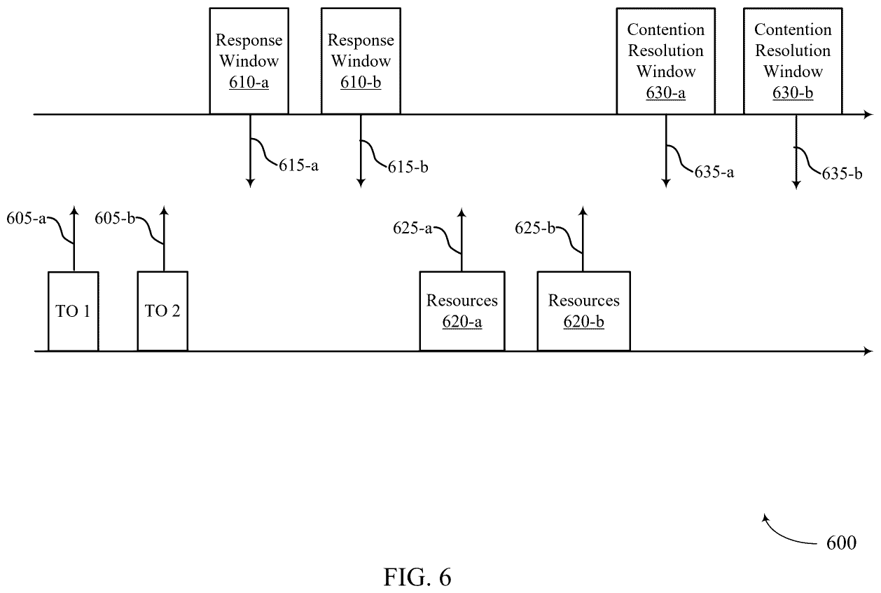

The network may similarly schedule various aspects of a RA procedure to avoid overlap between uplink and downlink signaling corresponding to multiple TOs of a TO group 505, as described in greater detail with reference to FIG. 6.

FIG. 6 shows an example of a timeline 600 that supports enhancements for diversity schemes for contention-based transmission in accordance with one or more aspects of the present disclosure. The timeline 600 may implement, or may be implemented by, aspects of the wireless communications system 100, the wireless communications system 200, the TO group 300, the TO grouping scheme 400, the timeline 500, or the timeline 501. For example, one or more UEs (e.g., UEs 115) and one or more network entities (e.g., network entities 105), which may be examples of corresponding devices described with reference to FIGS. 1-5, may communicate according to the timeline 600.

In some examples, the UE and the network entity may perform a RA procedure, such as a four-step RACH, according to one or more diversity schemes (e.g., via multiple TOs in a TO group). For instance, the UE may be configured with a TO group including multiple TOs that do not overlap in time (e.g., as described with reference to FIGS. 2-5). The UE may transmit a first RA message 605-a (e.g., msg 1) via the TO 1 and a second RA message 605-b (e.g., a copy of the msg 1) via the TO 2, where TO 1 and TO 2 are include in a same TO group. The UE may monitor for a response message 615-a (e.g., a RAR or other response message) during the response window 610-a corresponding to the TO 1, and may monitor for a response message 615-b (e.g., a RAR) during the response window 610-b corresponding to the TO 2. The response message 615-a (e.g., msg 2) may include a grant of resources 620-a for transmitting a data message (e.g., msg 3) corresponding to the RA message 605-a (e.g., and the TO 1). The response message 615-b (e.g., a copy of msg 2) may include a grant of resources 620-b for transmitting a copy of the data message (e.g., msg 3) corresponding to the RA message 605-b (e.g., and the TO 2). The UE may transmit the data message 625-a via the resources 620-a and may transmit the data message 625-b via the resources 620-b. The UE may monitor for a contention resolution message (e.g., msg 4 corresponding to the msg 1 transmitted via the TO 1) during the contention resolution window 630-a, and may monitor for a contention resolution message (e.g., msg 4 corresponding to the msg 1 transmitted via the TO 2) during the contention resolution window 630-b. As described herein, if even one of the RA procedures initiated via the TOs of the TO group is successful, the UE may save time and resources, and by completing one RA procedure, the UE may free up resources for other UEs to complete RA procedures with decreased interference. The UE may receive a contention resolution message 635-a via the contention resolution window 630-a. The UE may receive a contention resolution message 635-b via the contention resolution window 630-b.

The UE may not be expected to perform transmission (e.g., msg 1, msg 3, msg A, or data transmissions) overlapping in time with response windows (e.g., response windows 610 or contention resolution windows 630) corresponding to TOs in the same TO group. For example, the network may help to ensure that overlap between transmission of a TO (e.g., via the TO 1 or the TO 2) and a response window (e.g., the response window 610-a r the response window 610-b) is prevented (e.g., as described with reference to FIG. 5). The network may help to ensure that overlap between transmissions or retransmissions of data or msg 3 corresponding to a TO and a response window of a different TO in the TO group do not overlap. The network may help to ensure that transmission via a TO (e.g., msg 1) and a contention resolution window 630 of a different TO from the same TO group do not overlap (e.g., which may occur without restriction in the case of TOs separated by a time that spans one or more RTTs). The network may help to ensure that transmission or retransmission of msg 3 corresponding to a TO and a contention resolution window 630 of a different TO from the same TO group do not overlap. In some examples (e.g., for RACH-less EDT case), the network entity may help to ensure that data transmission or retransmissions corresponding to a TO and a contention resolution window of a different TO from the same TO group do not overlap.

Techniques described herein may be applied to other access or communication schemes (e.g., such as a RACH-less EDT procedure). For instance, the UE may transmit a first data message and a second data message (e.g., without a preamble) via the TO 1 and the TO 2. In such examples, the network may similarly help to ensure that a response window 610 for a response message including a contention resolution indication (e.g., that does not grant additional resources 620 but instead resolves the contention) does not overlap in time with the resources of any other TOs of the same TO group (e.g., the resources of the response windows 610 are different than the resources of the TOs of a TO group).

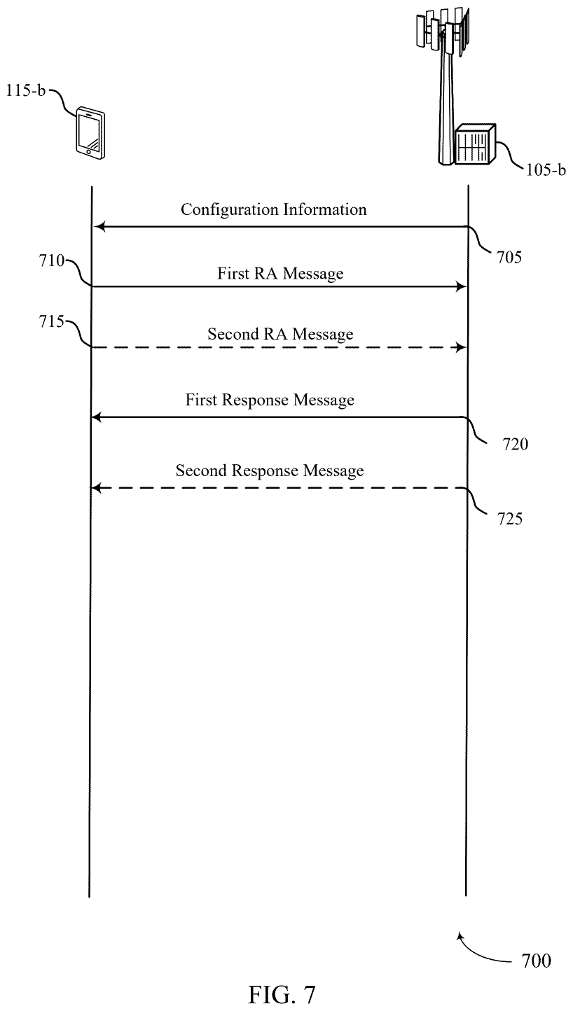

FIG. 7 shows an example of a process flow 700 that supports enhancements for diversity schemes for contention-based transmission in accordance with one or more aspects of the present disclosure. The process flow 700 may implement, or be implemented by, aspects of the wireless communications system 100, the wireless communications system 200, the TO group 300, the TO grouping scheme 400, the timeline 500, the timeline 600, or any combination thereof. For example, the process flow 700 may include a UE 115-b, and a network entity 105-b, which may be examples of corresponding devices described with reference to FIGS. 1-6.

At 705, the UE 115-b may receive (e.g., from the network entity 105-b) control signaling. The control signaling may indicate a configuration for a group of TOs including more than one TO, each TO in the group of TOs including a respective set of resources shared by multiple UEs for contention-based RA transmissions RACH-less transmissions, etc., where at least a first TO of the group of TOs occupies different time resources than (e.g., does not overlap with) at least a second TO of the group of TOs.

At 710, the UE 115-b may transmit (e.g., to the network entity 105-b) a first RA message (e.g., a first instance of a RA message) via the first TO and using a first resource from a first set of resources of the first TO.

At 715, the UE 115-b may transmit (e.g., to the network entity 105-b) a second RA message (e.g., a copy of the first RA message or a second instance of the first RA message) via the first TO and using a first resource from a first set of resources of the first TO.

In some examples, none of the more than one TO in the group of TOs occupy the same time resources as any other TO in the group of TOs. The network entity 105-b may configure the TOs of the TO group such that none of the TOs overlap in time.

In some examples, some of the TOs in the TO group may overlap, but other TOs in the TO group may not overlap. In such examples, the UE 115-b may select, from the group of TOs, the first TO and the second TO based at least in part on the first TO occupying different resources in time than the second TO (e.g., the UE 115-b may select TOs that occupy different resources in time, as described in greater detail with reference to FIG. 4).

At 720, the UE 115-b may receive at least one of a first response message corresponding to the first RA message or (e.g., at 725) a second response message corresponding to the second RA message. For example (e.g., in a four-step RACH procedure), the first response message received at 720 may include a first grant of resources for a first data message (e.g., a first instance of Msg 3) and the second response message (e.g., received at 725) may include a second grant of resources for a second data message (e.g., a second instance of Msg 3), and the first grant of resources and the second grant of resources occupy different resources in time (e.g., the network entity 105-b may schedule the first grant of resources and the second grant of resources so that they do not overlap in time and the UE is not expected to transmit multiple instance of Msg 3 at the same time).

In some examples, as described in greater detail with reference to FIGS. 4 and 5, the network entity 105-b may schedule response windows (e.g., for the response messages at 720 and 725 in a RACH-less or a contention-based procedure) so as not to overlap with any TOs of the TO group. In some examples, the response windows may be permitted to partially overlap with one or more TOs, but the UE may not be expected to monitor for a response message during a response window and simultaneously transmit via an overlapping TO (e.g., the network entity 105-b may transmit the response message for a given TO in a TO group during a response window such that the UE 115-b receive the response message prior to a transmission time for the overlapping TO. In a four-step RACH procedure, the UE 115-b may receive one or more of the first and second response messages (e.g., at 720 and 725, respectively), may transmit data messages (e.g., two instances of Msg 3), and may monitor for one or more instances of a contention resolution message (e.g., Msg 4) during one or more contention resolution windows. In a RACH-less scenario, the second message may include an indication of a contention resolution (e.g., corresponding to a given TO of a TO group).

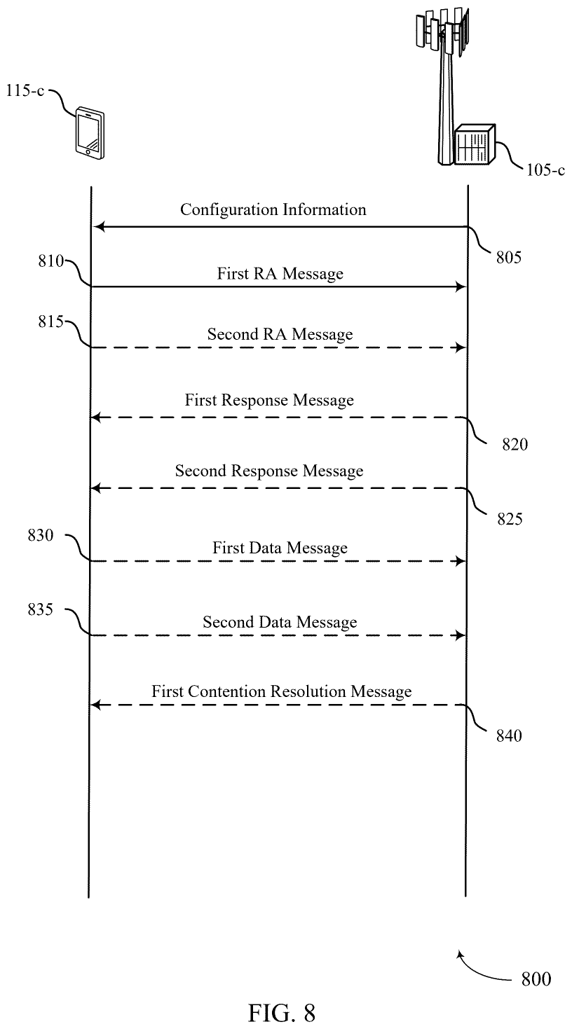

FIG. 8 shows an example of a process flow 800 that supports enhancements for diversity schemes for contention-based transmission in accordance with one or more aspects of the present disclosure. The process flow 800 may implement, or be implemented by, aspects of the wireless communications system 100, the wireless communications system 200, the TO group 300, the TO grouping scheme 400, the timeline 500, the timeline 501, the timeline 600, the process flow 700, or any combination thereof. For example, the process flow 800 may include a UE 115-c, and a network entity 105-c, which may be examples of corresponding devices described with reference to FIGS. 1-7. In some examples, the UE 115-b may be a half-duplex UE.

At 805, the UE 115-c may receive (e.g., from the network entity 105-c) control signaling. The control signaling may indicate a configuration for a group of TOs including more than one TO, each TO in the group of TOs including a respective set of resources shared by multiple UEs for contention-based RA transmissions RACH-less transmissions, etc. In some examples, at least a first TO of the group of TOs occupies different time resources than (e.g., does not overlap with) at least a second TO of the group of TOs.

At 810, the UE 115-c may transmit (e.g., to the network entity 105-c) a first RA message (e.g., a first instance of a RA message) via the first TO and using a first resource from a first set of resources of the first TO.

At 815, the UE 115-c may transmit (e.g., to the network entity 105-c) a second RA message (e.g., a copy of the first RA message or a second instance of the first RA message) via the first TO and using a first resource from a first set of resources of the first TO. In some examples (e.g., a four-step RACH procedure), the first and second RA messages may be instances of a Msg 1. In some examples (e.g., a RACH-less EDT or two-step RACH), the first and second RA messages may include data (e.g., and no preamble).

The UE 115-c may monitor for a first response message (e.g., at 820) for the first RA message via at least a first portion of a first response window corresponding to the first RA message and the first TO. The first response window corresponding to the first RA message may occupy different resources in time than the second TO according to the configuration of the group of TOs. For example, the network entity 105-c may configure the TO group and the response windows for the first RA message and the second RA message to not overlap in time. In some examples, a second portion of the first response window corresponding to the first RA message occupies different resources in time than at least a portion of the second TO according to the configuration of the group of TOs. In such examples, the UE 115-c may receive the first response message at 820 during the first portion of the first response window based at least in part on the monitoring. Transmission of the second RA message via the second TO may occur during the second portion of the first response window, and monitoring during the second portion of the first response window may be restricted (e.g., by the network entity 105-c, one or more rules, or one or more conditions being satisfied, among other examples). The UE 115-c may receive a second response message at 825, which may not overlap with any TO in the TO group.

In some examples (e.g., a RACH-less EDT procedure), the first response message may not include a grant of resources, but may include a contention resolution indication. In some examples (e.g., in a four-step RACH procedure), the UE 115-c may receive the first response message (e.g., at 820) based at least in part on monitoring during the first response window, and the first response message may include a grant of a first set of resources for transmitting a first data message, where the first set of resources occupies different resources than any response windows corresponding to the more than one TO of the group of TOs. That is, overlap between message 3 transmissions corresponding to a TO and a response window of a different TO from the same TO group is prevented. In such examples (e.g., a four-step RACH procedure), the UE 115-c may transmit the first data message via the first set of resources (e.g., at 830) according to the first response message. In some examples, the UE 115-c may also transmit a second data message at 835. The UE 115-c may monitor for a first contention resolution message (e.g., a first instance of Msg 4 at 840) via a contention resolution window, where the first set of resources occupies different resources in time than any contention resolution windows associated with one or more additional TOs of the more than one TO. That is, overlap between Msg 3 transmission and contention resolution windows of a different TO form the same TO group is prevented. Multiple response windows corresponding to the more than one TO may occupy different resources in time than any of the more than one TO. In some examples, multiple contention resolution windows corresponding to the more than one TO occupy different resources in time than any of the more than one TO. Thus, transmission via a TO and response windows of a different TO in the same TO group is prevented, and overlap between transmission of a TO and a contention resolution window of a different TO from the same TO group is prevented.

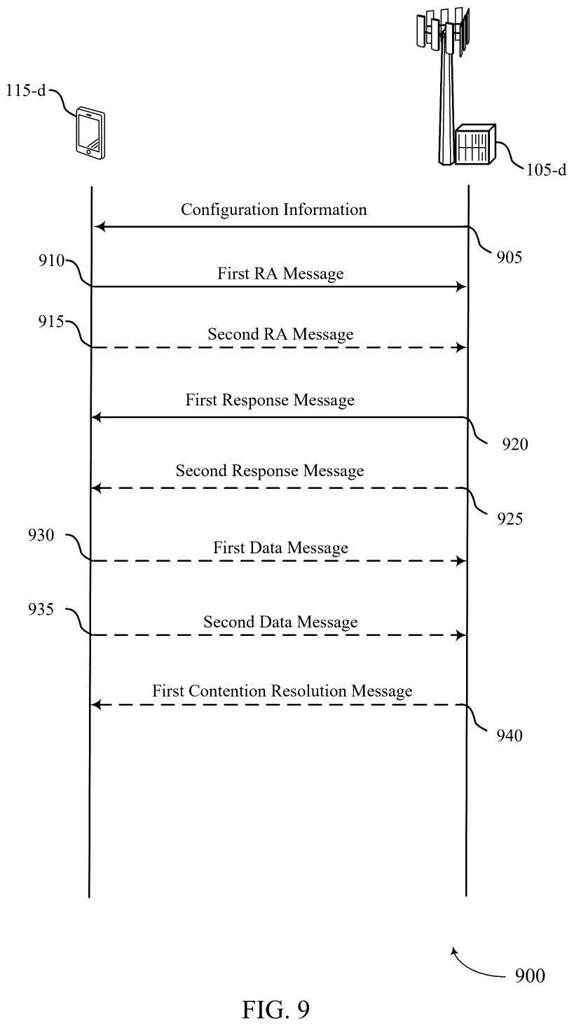

FIG. 9 shows an example of a process flow 900 that supports enhancements for diversity schemes for contention-based transmission in accordance with one or more aspects of the present disclosure. The process flow 900 may implement, or be implemented by, aspects of the wireless communications system 100, the wireless communications system 200, the TO group 300, the TO grouping scheme 400, the timeline 500, the timeline 501, the timeline 600, the process flow 700, the process flow 800, or any combination thereof. For example, the process flow 900 may include a UE 115-d, and a network entity 105-d, which may be examples of corresponding devices described with reference to FIGS. 1-8. The UE 115-d may perform an access procedure (e.g., a four-step RA procedure, or a RACH-less EDT, among other examples). In such examples, the UE 115-d may receive on or more requests for retransmission of a message (e.g., a retransmission of a data message for a RACH-less procedure, or a retransmission of a Msg 1 or Msg 3).

At 905, the UE 115-d may receive (e.g., from the network entity 105-d) control signaling. The control signaling may indicate a configuration for a group of TOs including more than one TO, each TO in the group of TOs including a respective set of resources shared by multiple UEs for contention-based RA transmissions RACH-less transmissions, etc. In some examples, at least a first TO of the group of TOs occupies different time resources than (e.g., does not overlap with) at least a second TO of the group of TOs.

At 910, the UE 115-d may transmit (e.g., to the network entity 105-d) a first RA message (e.g., a first instance of a RA message) via the first TO and using a first resource from a first set of resources of the first TO.

At 915, the UE 115-d may transmit (e.g., to the network entity 105-d) a second RA message (e.g., a copy of the first RA message or a second instance of the first RA message) via the first TO and using a first resource from a first set of resources of the first TO. In some examples (e.g., a four-step RACH procedure), the first and second RA messages may be instances of a Msg 1. In some examples (e.g., a RACH-less EDT or two-step RACH), the first and second RA messages may include data (e.g., and no preamble).

In the case of a four-step RA procedure, the UE 115-d may receive at least a first response message (e.g., at 920) during a first response window corresponding to the first TO. The first response message may include a grant of a first set of resources for transmitting a first data transmission. The UE 115-d may transmit the first data message (e.g., at 930) via the first set of resources according to the first response message, and may receive a first contention resolution message (e.g., at 940) corresponding to the first data message.

In some examples, the UE 115-d may send a retransmission of the second RA message (e.g., if the second RA response 925 is not received within a time window). However, having already received the first contention resolution message at 940, the UE 115-d may refrain from sending the retransmission of the second RA message transmitted at 915. In some examples, the UE 115-d may receive the second RA response at 925 (e.g., corresponding to the second RA message), and may transmit a second data message 935. The UE 115-d may receive a request to send a retransmission of the second data message (e.g., a retransmission of Msg 3). However, the UE 115-d may refrain from sending the retransmission of the second data message based at least in part on receiving the first contention resolution message for the first TO (e.g., at 940).

In some examples, the UE 115-d may transmit the first and second RA messages during a RACH-less procedure. In such examples, the first RA response message may include an indication of a contention resolution for the first RA message (e.g., transmitted via the first TO). In such examples, the UE 115-d may receive a request to send a retransmission of the second RA message (e.g., or may detect a trigger for retransmitting the second RA message, such as a time expiring for receiving the second RA response message). In such examples, the UE 115-d may refrain from sending the retransmission of the second instance of the RA message based at least in part on receiving the first response message including the contention resolution indication.

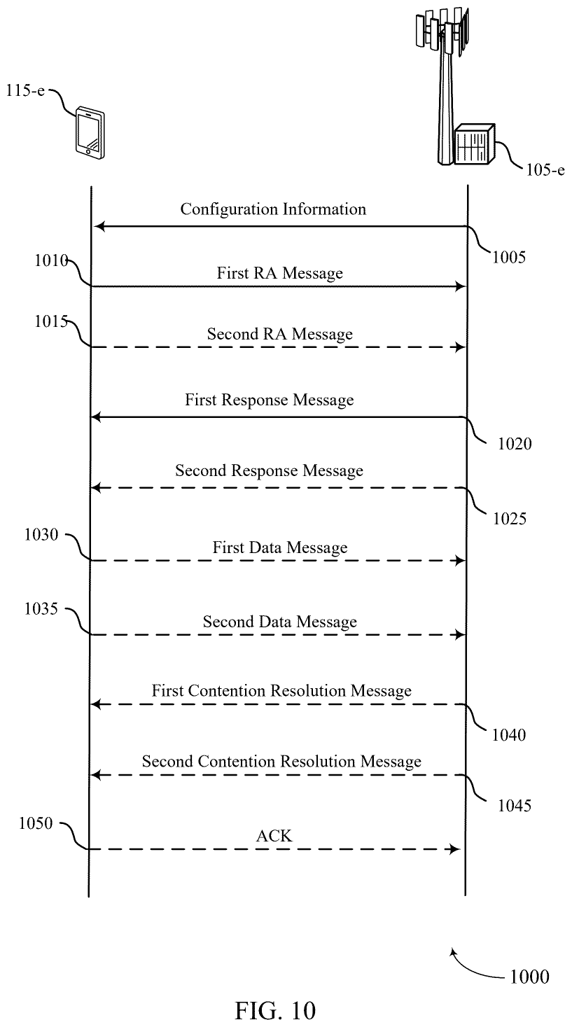

FIG. 10 shows an example of a process flow 1000 that supports enhancements for diversity schemes for contention-based transmission in accordance with one or more aspects of the present disclosure. The process flow 1000 may implement, or be implemented by, aspects of the wireless communications system 100, the wireless communications system 200, the TO group 300, the TO grouping scheme 400, the timeline 500, the timeline 501, the timeline 600, the process flow 700, the process flow 800, the process flow 900, or any combination thereof. For example, the process flow 900 may include a UE 115-c, and a network entity 105-e, which may be examples of corresponding devices described with reference to FIGS. 1-9. The UE 115-e may perform an access procedure (e.g., a four-step RA procedure, or a RACH-less EDT, among other examples). In such examples, the UE 115-e may receive multiple contention resolution indications (e.g., via Msg 4 in a four-step RA procedure, or via a response message in a RACH-less EDT procedure).

At 1005, the UE 115-e may receive (e.g., from the network entity 105-e) control signaling. The control signaling may indicate a configuration for a group of TOs including more than one TO, each TO in the group of TOs including a respective set of resources shared by multiple UEs for contention-based RA transmissions RACH-less transmissions, etc. In some examples, at least a first TO of the group of TOs occupies different time resources than (e.g., does not overlap with) at least a second TO of the group of TOs.

At 1010, the UE 115-e may transmit (e.g., to the network entity 105-e) a first RA message (e.g., a first instance of a RA message) via the first TO and using a first resource from a first set of resources of the first TO.

At 1015, the UE 115-e may transmit (e.g., to the network entity 105-e) a second RA message (e.g., a copy of the first RA message or a second instance of the first RA message) via the first TO and using a first resource from a first set of resources of the first TO. In some examples (e.g., a four-step RACH procedure), the first and second RA messages may be instances of a Msg 1. In some examples (e.g., a RACH-less EDT or two-step RACH), the first and second RA messages may include data (e.g., and no preamble).

Having transmitted the first RA message (e.g., at 1010) and the second RA message (e.g., at 1015), the UE 115-e may receive at least one of a first RA response message (e.g., at 1020) corresponding to the first RA message and including a first TC-RNTI and a first contention resolution indication (e.g., in a RACH-less procedure), a second RA response message (e.g., at 1025) corresponding to the first RA message and including an indication of a second TC-RNTI and a second contention resolution indication (e.g., in a RACH-less procedure), a first contention resolution message at 1040 (e.g., responsive to reception of the first response message at 1020 and transmission of the first data message at 1030 in a four-step RA procedure), or a second contention resolution message 1040 (e.g., responsive to reception of the second response message at 1025 and transmission of the second data message at 1035 in a four-step RA procedure).

For example, in a four-step RA procedure, the UE 115-e may receive two contention resolutions corresponding to the first TO and the second TO. In a two-step (e.g., RACH-less) procedure, the UE 115-e may receive two response messages (e.g., at 1020 and 1025, respectively) corresponding to the first TO and the second TO. In either case, two access procedures have been successfully resolved, as indicated by two indications of contention resolution. In some examples, multiple access procedures may be resolved, but the network entity 105-e may select one of the resolved access procedures and transmit only one contention resolution indication (e.g., via the response message in a RACH-less procedure or via the contention resolution message in a four-step RA procedure).

In some examples, the network entity 105-e may receive the first data message at 1030, and the second data message at 1035 (e.g., in a four-step RACH procedure) or may receive the first RA message at 1010 and the second RA message at 1015. As all transmission copies contain the same contention resolution identifier, the network entity 105-e may determine that all such copies are from the same UE 115-c, and may respond with a successful contention resolution (e.g., via the first response message or via the first contention resolution message) for only one of the copies and may wait for an acknowledgment from the UE 115-c. For instance, the network entity may transmit only the first response message at 1020 (e.g., in a RACH-less EDT procedure), or only the first contention resolution message at 1040 (e.g., in a four-step RACH procedure), and the UE 115-e may transmit a responsive ACK at 1050 indicating successful receipt of the indication of a successful contention resolution. In such examples, the response message received at 1020, or the first contention resolution message received at 1040, may include an indication of a new C-RNTI for the UE 115-c to use for subsequent communications. The success response (e.g., the indication of the contention resolution) may include a flag and a new C-RNTI for the UE 115-e to use. In some examples, the UE 115-e may promote the RNTI (e.g., a temporary C-RNTI (TC-RNTI) to a non-temporary C-RNTI for the access procedure corresponding to the indication of success (e.g., if the UE 115-e receives the first response message at 1020 for the first TO, or the first contention resolution message at 1040 for the first TO, then the UE 115-e may promote the first RNTI (e.g., a TC-RNTI) to a new RNTI (e.g., a non-temporary C-RNTI). For example, in a RACH-less EDT procedure where the first response message includes an indication of a contention resolution, a previously configured RNTI (e.g., which may be a temporary RNTI, such as a TC-RNTI). The RNTI may be associated with the RA message (e.g., and the second RA message) transmitted on corresponding resources. One example of such an RNTI may be a TC-RNTI, as described herein. In such examples, as described herein the RNTI (e.g., a TC-RNTI) may be promoted to a C-RNTI upon receiving the contention resolution message or the response message indicating the contention resolution.

In some examples, the network entity 105-e may send multiple successful contention resolution indications to the UE 115-c, and may wait for the ACK at 1050 for only one of the successfully resolved access procedures. For instance, the UE 115-c may decode multiple successful contention resolution responses (e.g., the first response message and the second response messages at 1020 and 1025, respectively, in a RACH-less or two-step RACH procedure, or the first contention resolution message and the second contention resolution message at 1040 and 1045, respectively, for a four-step RACH procedure). The UE 115-c may decode multiple successful contention resolution responses, and may choose one of them according to a rule or one or more conditions or an explicit instruction from the network entity 105-c. For instance, the UE may randomly select the first access procedure (e.g., the first contention resolution indication corresponding to the first TO), or may select the first access procedure based on the lowest TC_RNTI value, or based on any other criteria. The UE 115-e may send the ACK message at 1050 indicating successful receipt of the first contention resolution indication (e.g., at 1020 or at 1040) according to the selection. The success response (e.g., the indication of the contention resolution) may include a flag and a new C-RNTI for the UE 115-e to use. In some examples, the UE 115-e may promote the RNTI (e.g., a TC-RNTI) to a non-temporary C-RNTI for the access procedure corresponding to the indication of success (e.g., if the UE 115-e receives the first response message at 1020 for the first TO, or the first contention resolution message at 1040 for the first TO, then the UE 115-c may promote the first TC-RNTI to a non-temporary C-RNTI).

As described herein, upon reception of, or selection of, a contention resolution response (e.g., at 1020 or at 1040), the UE 115-c may stop all contention resolution timers that do not correspond to the selected or received contention resolution response (e.g., the UE 115-e may stop a contention resolution timer corresponding to the second TO and the second RA message transmitted at 1015, and may stop monitoring for the second RA message during a pending response window or may stop monitoring for the second contention resolution message during a pending contention resolution window. The UE 115-e may not perform any retransmissions for any corresponding transmissions associated with the same TO group (e.g., of the second RA message, or the second data message). The UE 115-e may choose among successful contention resolution responses (e.g., indicated at 1020 and 1025, or indicated at 1040 and 1045) according to a predefined rule. The UE 115-e may be configured to transmit pointers to the other transmission copies associated with the same TO group. For example, the ACK message transmitted at 1050 may include an indication of the other transmission copies associated with the same TO group (e.g., may include an indication of the second TO, the second access procedure, the second RNTI, a common identifier for the TOs of the TO group or the TO group or the access procedures, or any combination thereof).

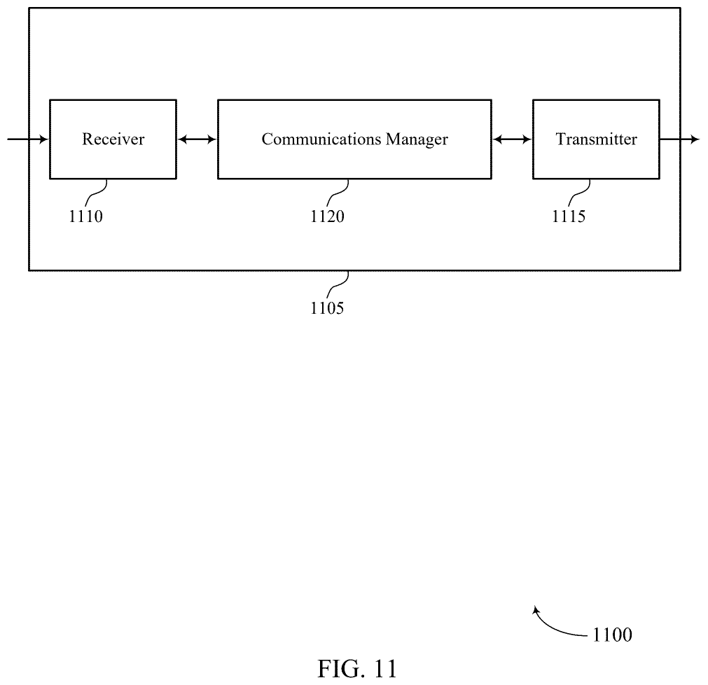

FIG. 11 shows a block diagram 1100 of a device 1105 that supports enhancements for diversity schemes for contention-based transmission in accordance with one or more aspects of the present disclosure. The device 1105 may be an example of aspects of a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to enhancements for diversity schemes for contention-based transmission). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to enhancements for diversity schemes for contention-based transmission). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations or components thereof may be examples of means for performing various aspects of enhancements for diversity schemes for contention-based transmission as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions. The communications manager 1120 is capable of, configured to, or operable to support a means for transmitting a first random access message via the first transmission occasion and using a first resource from a first set of resources of the first transmission occasion. The communications manager 1120 is capable of, configured to, or operable to support a means for transmitting a second random access message via the second transmission occasion and using a second resource from a second set of resources of the second transmission occasion. The communications manager 1120 is capable of, configured to, or operable to support a means for monitoring for at least one of a first response message corresponding to the first random access message or a second response message corresponding to the second random access message.

Additionally, or alternatively, the communications manager 1120 may support wireless communications in accordance with examples as disclosed herein. For example, the communications manager 1120 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The communications manager 1120 is capable of, configured to, or operable to support a means for transmitting a first random access message via the first transmission occasion and using a first resource from a first set of resources of the first transmission occasion. The communications manager 1120 is capable of, configured to, or operable to support a means for monitoring for a first response message via at least a first portion of a first response window corresponding to the first random access message and the first transmission occasion. The communications manager 1120 is capable of, configured to, or operable to support a means for transmitting a second random access message via the second transmission occasion and using a second resource from a second set of resources of the second transmission occasion, where the second resource occupies different resources in time than at least the first portion of the first response window.

Additionally, or alternatively, the communications manager 1120 may support wireless communications in accordance with examples as disclosed herein. For example, the communications manager 1120 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The communications manager 1120 is capable of, configured to, or operable to support a means for transmitting a first random access message via the first transmission occasion and using a first resource from a first set of resources of the first transmission occasion. The communications manager 1120 is capable of, configured to, or operable to support a means for transmitting a second random access message via the second transmission occasion and using a second resource from a second set of resources of the second transmission occasion. The communications manager 1120 is capable of, configured to, or operable to support a means for receiving at least a first response message during a first response window corresponding to the first transmission occasion, where the first response message includes a grant of a first set of resources for transmitting a first data transmission. The communications manager 1120 is capable of, configured to, or operable to support a means for transmitting a first data message via the first set of resources according to the first response message. The communications manager 1120 is capable of, configured to, or operable to support a means for receiving a first contention resolution message corresponding to the first data message.

Additionally, or alternatively, the communications manager 1120 may support wireless communications in accordance with examples as disclosed herein. For example, the communications manager 1120 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions. The communications manager 1120 is capable of, configured to, or operable to support a means for transmitting a first instance of a random access message via the first transmission occasion and using a first resource from a first set of resources of the first transmission occasion. The communications manager 1120 is capable of, configured to, or operable to support a means for transmitting a second instance of the random access message via the second transmission occasion and using a second resource from a second set of resources of the second transmission occasion. The communications manager 1120 is capable of, configured to, or operable to support a means for receiving at least a first response message during a first response window corresponding to the first transmission occasion, where the first response message includes a contention resolution indication corresponding to the first transmission occasion.

Additionally, or alternatively, the communications manager 1120 may support wireless communications in accordance with examples as disclosed herein. For example, the communications manager 1120 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The communications manager 1120 is capable of, configured to, or operable to support a means for transmitting a first random access message via the first transmission occasion and using a first resource from a first set of resources of the first transmission occasion and a second random access message via the second transmission occasion and using a second resource from a second set of resources of the second transmission occasion. The communications manager 1120 is capable of, configured to, or operable to support a means for receiving at least one of a first response message including a first contention resolution indication during a first response window corresponding to the first transmission occasion, a second response message including a second contention resolution indication during a second response window corresponding to the second transmission occasion, a first contention resolution message including the first contention resolution indication, the first contention resolution message responsive to transmission of a first data message based on reception of the first response message, or a second contention resolution message including the second contention resolution indication, the second contention resolution message responsive to transmission of a second data message based on reception of the second response message, where the first response message or the first contention resolution message includes a first-RNTI and where the second response message or the second contention resolution message includes a second RNTI.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for access procedures resulting in more efficient utilization of communication resources, improved throughput, more reliable communication, and improved user experience.

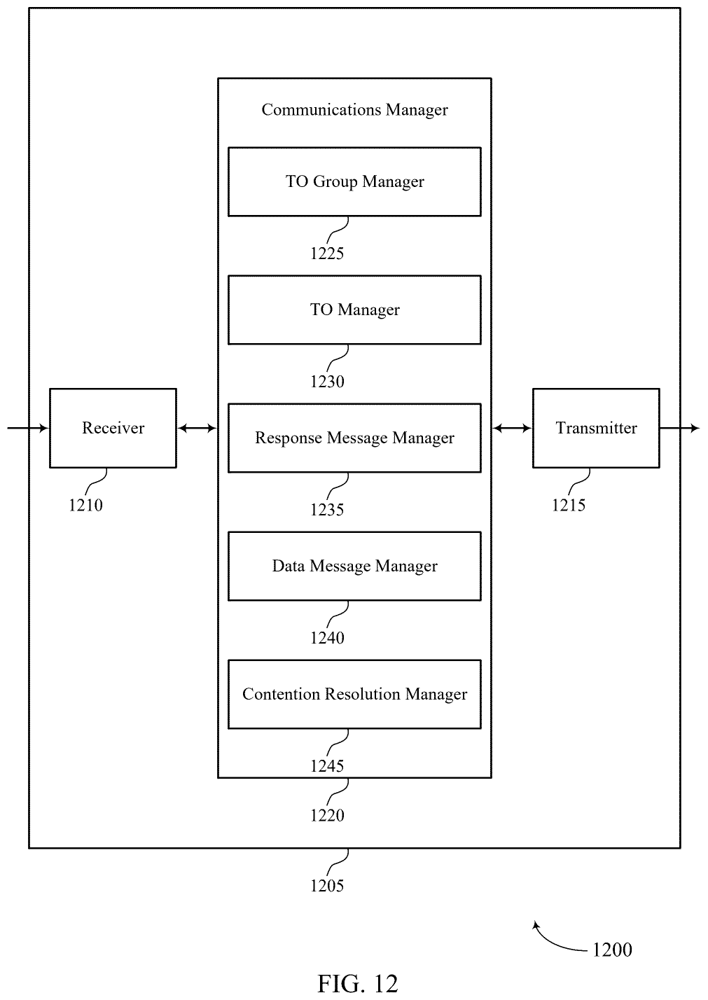

FIG. 12 shows a block diagram 1200 of a device 1205 that supports enhancements for diversity schemes for contention-based transmission in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205, or one of more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to enhancements for diversity schemes for contention-based transmission). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to enhancements for diversity schemes for contention-based transmission). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of enhancements for diversity schemes for contention-based transmission as described herein. For example, the communications manager 1220 may include a TO group manager 1225, a TO manager 1230, a response message manager 1235, a data message manager 1240, a contention resolution manager 1245, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The TO group manager 1225 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions. The TO manager 1230 is capable of, configured to, or operable to support a means for transmitting a first random access message via the first transmission occasion and using a first resource from a first set of resources of the first transmission occasion. The TO manager 1230 is capable of, configured to, or operable to support a means for transmitting a second random access message via the second transmission occasion and using a second resource from a second set of resources of the second transmission occasion. The response message manager 1235 is capable of, configured to, or operable to support a means for monitoring for at least one of a first response message corresponding to the first random access message or a second response message corresponding to the second random access message.

Additionally, or alternatively, the communications manager 1220 may support wireless communications in accordance with examples as disclosed herein. The TO group manager 1225 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The TO manager 1230 is capable of, configured to, or operable to support a means for transmitting a first random access message via the first transmission occasion and using a first resource from a first set of resources of the first transmission occasion. The response message manager 1235 is capable of, configured to, or operable to support a means for monitoring for a first response message via at least a first portion of a first response window corresponding to the first random access message and the first transmission occasion. The TO manager 1230 is capable of, configured to, or operable to support a means for transmitting a second random access message via the second transmission occasion and using a second resource from a second set of resources of the second transmission occasion, where the second resource occupies different resources in time than at least the first portion of the first response window.

Additionally, or alternatively, the communications manager 1220 may support wireless communications in accordance with examples as disclosed herein. The TO group manager 1225 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The TO manager 1230 is capable of, configured to, or operable to support a means for transmitting a first random access message via the first transmission occasion and using a first resource from a first set of resources of the first transmission occasion. The TO manager 1230 is capable of, configured to, or operable to support a means for transmitting a second random access message via the second transmission occasion and using a second resource from a second set of resources of the second transmission occasion. The response message manager 1235 is capable of, configured to, or operable to support a means for receiving at least a first response message during a first response window corresponding to the first transmission occasion, where the first response message includes a grant of a first set of resources for transmitting a first data transmission. The data message manager 1240 is capable of, configured to, or operable to support a means for transmitting a first data message via the first set of resources according to the first response message. The contention resolution manager 1245 is capable of, configured to, or operable to support a means for receiving a first contention resolution message corresponding to the first data message.

Additionally, or alternatively, the communications manager 1220 may support wireless communications in accordance with examples as disclosed herein. The TO group manager 1225 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions. The TO manager 1230 is capable of, configured to, or operable to support a means for transmitting a first instance of a random access message via the first transmission occasion and using a first resource from a first set of resources of the first transmission occasion. The TO manager 1230 is capable of, configured to, or operable to support a means for transmitting a second instance of the random access message via the second transmission occasion and using a second resource from a second set of resources of the second transmission occasion. The response message manager 1235 is capable of, configured to, or operable to support a means for receiving at least a first response message during a first response window corresponding to the first transmission occasion, where the first response message includes a contention resolution indication corresponding to the first transmission occasion.

Additionally, or alternatively, the communications manager 1220 may support wireless communications in accordance with examples as disclosed herein. The TO group manager 1225 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The TO manager 1230 is capable of, configured to, or operable to support a means for transmitting a first random access message via the first transmission occasion and using a first resource from a first set of resources of the first transmission occasion and a second random access message via the second transmission occasion and using a second resource from a second set of resources of the second transmission occasion. The contention resolution manager 1245 is capable of, configured to, or operable to support a means for receiving at least one of a first response message including a first contention resolution indication during a first response window corresponding to the first transmission occasion, a second response message including a second contention resolution indication during a second response window corresponding to the second transmission occasion, a first contention resolution message including the first contention resolution indication, the first contention resolution message responsive to transmission of a first data message based on reception of the first response message, or a second contention resolution message including the second contention resolution indication, the second contention resolution message responsive to transmission of a second data message based on reception of the second response message, where the first response message or the first contention resolution message includes a first RNTI and where the second response message or the second contention resolution message includes a second RNTI.

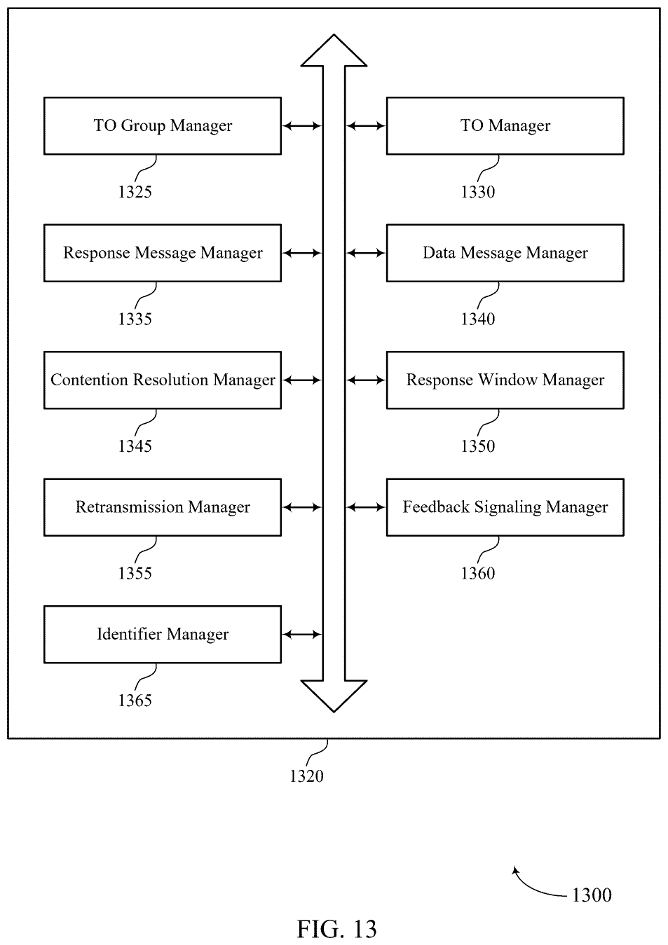

FIG. 13 shows a block diagram 1300 of a communications manager 1320 that supports enhancements for diversity schemes for contention-based transmission in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of enhancements for diversity schemes for contention-based transmission as described herein. For example, the communications manager 1320 may include a TO group manager 1325, a TO manager 1330, a response message manager 1335, a data message manager 1340, a contention resolution manager 1345, a response window manager 1350, a retransmission manager 1355, a feedback signaling manager 1360, an identifier manager 1365, or any combination thereof. Each of these components, or components or subcomponents thereof (e.g., one or more processors, one or more memories), may communicate, directly or indirectly, with one another (e.g., via one or more buses).

The communications manager 1320 may support wireless communications in accordance with examples as disclosed herein. The TO group manager 1325 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions. The TO manager 1330 is capable of, configured to, or operable to support a means for transmitting a first random access message via the first transmission occasion and using a first resource from a first set of resources of the first transmission occasion. In some examples, the TO manager 1330 is capable of, configured to, or operable to support a means for transmitting a second random access message via the second transmission occasion and using a second resource from a second set of resources of the second transmission occasion. The response message manager 1335 is capable of, configured to, or operable to support a means for monitoring for at least one of a first response message corresponding to the first random access message or a second response message corresponding to the second random access message.

In some examples, none of the more than one transmission occasion in the group of transmission occasions occupy the same time resources as any other transmission occasion in the group of transmission occasions.

In some examples, the TO manager 1330 is capable of, configured to, or operable to support a means for selecting, from the group of transmission occasions, the first transmission occasion and the second transmission occasion based on the first transmission occasion occupying different resources in time than the second transmission occasion.

In some examples, the response message manager 1335 is capable of, configured to, or operable to support a means for receiving at least one of the first response message and the second response message, where the first response message includes a first grant of resources for a first data message and the second response message includes a second grant of resources for a second data message, where the first grant of resources and the second grant of resources occupy different resources in time.

In some examples, to support monitoring for at least one of the first response message and the second response message, the response window manager 1350 is capable of, configured to, or operable to support a means for monitoring for the first response message during at least a portion of a first response window, and monitoring for the second response message during at least a portion of a second response window, where at least the portion of the first response window and at least the portion of the second response window occupy different resources in time.

Additionally, or alternatively, the communications manager 1320 may support wireless communications in accordance with examples as disclosed herein. In some examples, the TO group manager 1325 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. In some examples, the TO manager 1330 is capable of, configured to, or operable to support a means for transmitting a first random access message via the first transmission occasion and using a first resource from a first set of resources of the first transmission occasion. In some examples, the response message manager 1335 is capable of, configured to, or operable to support a means for monitoring for a first response message via at least a first portion of a first response window corresponding to the first random access message and the first transmission occasion. In some examples, the TO manager 1330 is capable of, configured to, or operable to support a means for transmitting a second random access message via the second transmission occasion and using a second resource from a second set of resources of the second transmission occasion, where the second resource occupies different resources in time than at least the first portion of the first response window.

In some examples, the first response window corresponding to the first random access message occupies different resources in time than the second transmission occasion according to the configuration of the group of transmission occasions.

In some examples, a second portion of the first response window corresponding to the first random access message occupies different resources in time than at least a portion of the second transmission occasion according to the configuration of the group of transmission occasions.

In some examples, the response message manager 1335 is capable of, configured to, or operable to support a means for receiving the first response message during the first portion of the first response window based on the monitoring, where transmission of the second random access message via the second transmission occasion occurs during the second portion of the first response window, and monitoring during the second portion of the first response window is restricted.

In some examples, the response message manager 1335 is capable of, configured to, or operable to support a means for receiving the first response message based on the monitoring, the first response message including a grant of a first set of resources for transmitting a first data message, where the first set of resources occupies different resources than any response windows corresponding to the more than one transmission occasion of the group of transmission occasions.

In some examples, the data message manager 1340 is capable of, configured to, or operable to support a means for transmitting the first data message via the first set of resources according to the first response message. In some examples, the contention resolution manager 1345 is capable of, configured to, or operable to support a means for monitoring for a first contention resolution message corresponding to the first data message via a contention resolution window, where the first set of resources occupies different resources in time than any contention resolution windows associated with one or more additional transmission occasions of the more than one transmission occasion.

In some examples, a set of multiple response windows corresponding to the more than one transmission occasion occupies different resources in time than any of the more than one transmission occasion.

In some examples, a set of multiple contention resolution windows corresponding to the more than one transmission occasion occupy different resources in time than any of the more than one transmission occasion.

Additionally, or alternatively, the communications manager 1320 may support wireless communications in accordance with examples as disclosed herein. In some examples, the TO group manager 1325 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. In some examples, the TO manager 1330 is capable of, configured to, or operable to support a means for transmitting a first random access message via the first transmission occasion and using a first resource from a first set of resources of the first transmission occasion. In some examples, the TO manager 1330 is capable of, configured to, or operable to support a means for transmitting a second random access message via the second transmission occasion and using a second resource from a second set of resources of the second transmission occasion. In some examples, the response message manager 1335 is capable of, configured to, or operable to support a means for receiving at least a first response message during a first response window corresponding to the first transmission occasion, where the first response message includes a grant of a first set of resources for transmitting a first data transmission. The data message manager 1340 is capable of, configured to, or operable to support a means for transmitting a first data message via the first set of resources according to the first response message. The contention resolution manager 1345 is capable of, configured to, or operable to support a means for receiving a first contention resolution message corresponding to the first data message.

In some examples, the retransmission manager 1355 is capable of, configured to, or operable to support a means for sending a retransmission of the second random access message. In some examples, the retransmission manager 1355 is capable of, configured to, or operable to support a means for refraining from sending the retransmission of the second random access message based on receiving the first contention resolution message.

In some examples, the response message manager 1335 is capable of, configured to, or operable to support a means for receiving a second response message during a second response window corresponding to the second transmission occasion based on transmitting the second random access message, where the second response message includes a grant of a second set of resources for transmitting a second data transmission. In some examples, the data message manager 1340 is capable of, configured to, or operable to support a means for transmitting a second data message via the second set of resources according to the second response message.

In some examples, the retransmission manager 1355 is capable of, configured to, or operable to support a means for receiving a request to send a retransmission of the second data message. In some examples, the retransmission manager 1355 is capable of, configured to, or operable to support a means for refraining from sending the retransmission of the second data message based on receiving the first contention resolution message.

Additionally, or alternatively, the communications manager 1320 may support wireless communications in accordance with examples as disclosed herein. In some examples, the TO group manager 1325 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions. In some examples, the TO manager 1330 is capable of, configured to, or operable to support a means for transmitting a first instance of a random access message via the first transmission occasion and using a first resource from a first set of resources of the first transmission occasion. In some examples, the TO manager 1330 is capable of, configured to, or operable to support a means for transmitting a second instance of the random access message via the second transmission occasion and using a second resource from a second set of resources of the second transmission occasion. In some examples, the response message manager 1335 is capable of, configured to, or operable to support a means for receiving at least a first response message during a first response window corresponding to the first transmission occasion, where the first response message includes a contention resolution indication corresponding to the first transmission occasion.

In some examples, the retransmission manager 1355 is capable of, configured to, or operable to support a means for receiving a request to send a retransmission of the second instance of the random access message. In some examples, the retransmission manager 1355 is capable of, configured to, or operable to support a means for refraining from sending the retransmission of the second instance of the random access message based on receiving the first response message including the contention resolution indication.

Additionally, or alternatively, the communications manager 1320 may support wireless communications in accordance with examples as disclosed herein. In some examples, the TO group manager 1325 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. In some examples, the TO manager 1330 is capable of, configured to, or operable to support a means for transmitting a first random access message via the first transmission occasion and using a first resource from a first set of resources of the first transmission occasion and a second random access message via the second transmission occasion and using a second resource from a second set of resources of the second transmission occasion. In some examples, the contention resolution manager 1345 is capable of, configured to, or operable to support a means for receiving at least one of a first response message including a first contention resolution indication during a first response window corresponding to the first transmission occasion, a second response message including a second contention resolution indication during a second response window corresponding to the second transmission occasion, a first contention resolution message including the first contention resolution indication, the first contention resolution message responsive to transmission of a first data message based on reception of the first response message, or a second contention resolution message including the second contention resolution indication, the second contention resolution message responsive to transmission of a second data message based on reception of the second response message, where the first response message or the first contention resolution message includes a first RNTI and where the second response message or the second contention resolution message includes a second temporary RNTI.

In some examples, the feedback signaling manager 1360 is capable of, configured to, or operable to support a means for transmitting an acknowledgement message corresponding to the first contention resolution indication.

In some examples, the identifier manager 1365 is capable of, configured to, or operable to support a means for obtaining a new C-RNTI indicated in the first contention resolution message or the first response message. In some examples, the identifier manager 1365 is capable of, configured to, or operable to support a means for performing wireless communications with a network entity according to the new C-RNTI.

In some examples, the identifier manager 1365 is capable of, configured to, or operable to support a means for promoting the first RNTI to a non-temporary RNTI based on receiving the first contention resolution message or the first response message. In some examples, the identifier manager 1365 is capable of, configured to, or operable to support a means for performing wireless communications with a network entity according to the non-temporary C-RNTI.

In some examples, the acknowledgement message includes an indication of one or more copies of the first random access message, one or more copies of the first data message, or a combination thereof, corresponding to one or more additional transmission occasions of the more than one transmission occasion of the group of transmission occasions.

In some examples, the UE ceases monitoring for the second response message or monitoring for the second contention resolution message upon receiving the first response message or upon receiving the first contention resolution message.

In some examples, the contention resolution manager 1345 is capable of, configured to, or operable to support a means for receiving the first contention resolution indication. In some examples, the contention resolution manager 1345 is capable of, configured to, or operable to support a means for receiving the second contention resolution indication. In some examples, the contention resolution manager 1345 is capable of, configured to, or operable to support a means for selecting the first contention resolution indication. In some examples, the feedback signaling manager 1360 is capable of, configured to, or operable to support a means for transmitting a first acknowledgement message corresponding to the first contention resolution indication based on the selecting.

In some examples, the feedback signaling manager 1360 is capable of, configured to, or operable to support a means for refraining from transmitting a second acknowledgement message corresponding to the second contention resolution indication based on the selecting.

In some examples, the selecting includes a random selection of the first contention resolution indication from a set of multiple contention resolution.

In some examples, selecting the first contention resolution indication is based on the first RNTI having a lower value than the second RNTI, a timing of the first data message and the second data message, an order in time of the more than one transmission occasion of the group of transmission occasions, a preconfigured rule, one or more index values corresponding to the more than one transmission occasion, an instruction from a network entity, or any combination thereof.

In some examples, the identifier manager 1365 is capable of, configured to, or operable to support a means for selecting a first new C-RNTI indicated in the first contention resolution message or the first response message based on selecting the first contention resolution indication, where the second contention resolution message or the second response message indicates a second new C-RNTI. In some examples, the identifier manager 1365 is capable of, configured to, or operable to support a means for updating the first RNTI to a first new RNTI indicated in the first contention resolution message or the first response message. In some examples, the identifier manager 1365 is capable of, configured to, or operable to support a means for communicating with a network entity according to a first updated C-RNTI, where the first contention resolution message or the first response message includes the first updated C-RNTI, and the second contention resolution message or the second response message includes a second updated C-RNTI.

In some examples, the identifier manager 1365 is capable of, configured to, or operable to support a means for promoting the first RNTI to a non-temporary RNTI based on the selecting. In some examples, the identifier manager 1365 is capable of, configured to, or operable to support a means for performing wireless communications with a network entity according to the non-temporary C-RNTI.

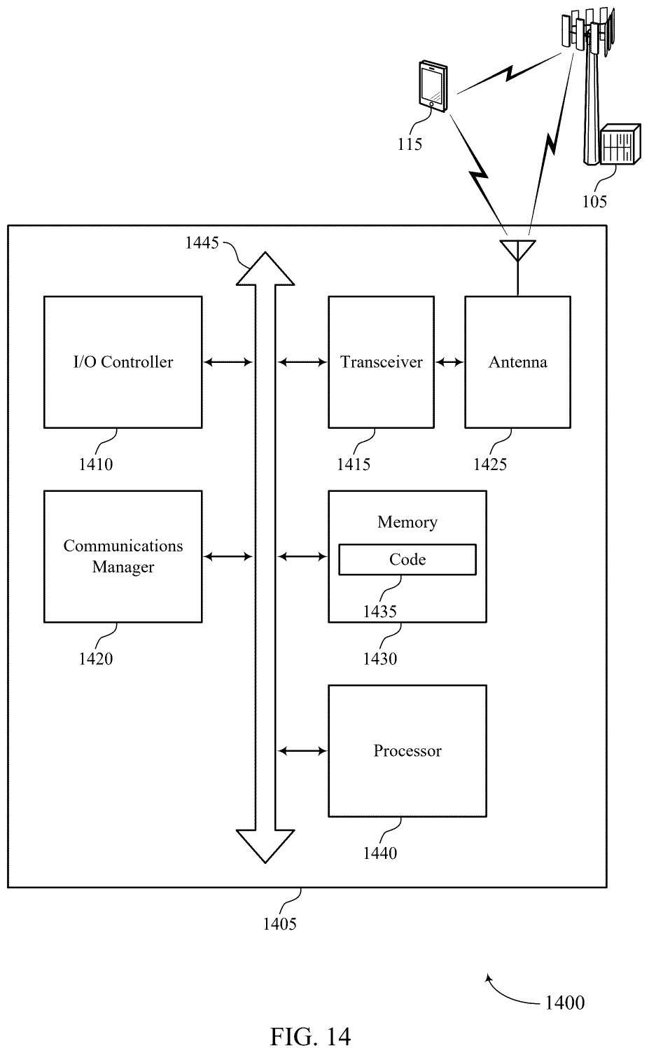

FIG. 14 shows a diagram of a system 1400 including a device 1405 that supports enhancements for diversity schemes for contention-based transmission in accordance with one or more aspects of the present disclosure. The device 1405 may be an example of or include components of a device 1105, a device 1205, or a UE 115 as described herein. The device 1405 may communicate (e.g., wirelessly) with one or more other devices (e.g., network entities 105, UEs 115, or a combination thereof). The device 1405 may include components for bi-directional voice and data communications including components for transmitting and receiving communications, such as a communications manager 1420, an input/output (I/O) controller, such as an I/O controller 1410, a transceiver 1415, one or more antennas 1425, at least one memory 1430, code 1435, and at least one processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of one or more processors, such as the at least one processor 1440. In some cases, a user may interact with the device 1405 via the I/O controller 1410 or via hardware components controlled by the I/O controller 1410.

In some cases, the device 1405 may include a single antenna. However, in some other cases, the device 1405 may have more than one antenna, which may be capable of concurrently transmitting or receiving multiple wireless transmissions. The transceiver 1415 may communicate bi-directionally via the one or more antennas 1425 using wired or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The at least one memory 1430 may include random access memory (RAM) and read-only memory (ROM). The at least one memory 1430 may store computer-readable, computer-executable, or processor-executable code, such as the code 1435. The code 1435 may include instructions that, when executed by the at least one processor 1440, cause the device 1405 to perform various functions described herein. The code 1435 may be stored in a non-transitory computer-readable medium such as system memory or another type of memory. In some cases, the code 1435 may not be directly executable by the at least one processor 1440 but may cause a computer (e.g., when compiled and executed) to perform functions described herein. In some cases, the at least one memory 1430 may include, among other things, a basic I/O system (BIOS) which may control basic hardware or software operation such as the interaction with peripheral components or devices.

The at least one processor 1440 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1440 may be configured to operate a memory array using a memory controller. In some other cases, a memory controller may be integrated into the at least one processor 1440. The at least one processor 1440 may be configured to execute computer-readable instructions stored in a memory (e.g., the at least one memory 1430) to cause the device 1405 to perform various functions (e.g., functions or tasks supporting enhancements for diversity schemes for contention-based transmission). For example, the device 1405 or a component of the device 1405 may include at least one processor 1440 and at least one memory 1430 coupled with or to the at least one processor 1440, the at least one processor 1440 and the at least one memory 1430 configured to perform various functions described herein.

In some examples, the at least one processor 1440 may include multiple processors and the at least one memory 1430 may include multiple memories. One or more of the multiple processors may be coupled with one or more of the multiple memories, which may, individually or collectively, be configured to perform various functions described herein. In some examples, the at least one processor 1440 may be a component of a processing system, which may refer to a system (such as a series) of machines, circuitry (including, for example, one or both of processor circuitry (which may include the at least one processor 1440) and memory circuitry (which may include the at least one memory 1430)), or components, that receives or obtains inputs and processes the inputs to produce, generate, or obtain a set of outputs. The processing system may be configured to perform one or more of the functions described herein. For example, the at least one processor 1440 or a processing system including the at least one processor 1440 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code 1435 (e.g., processor-executable code) stored in the at least one memory 1430 or otherwise, to perform one or more of the functions described herein.

The communications manager 1420 may support wireless communications in accordance with examples as disclosed herein. For example, the communications manager 1420 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions. The communications manager 1420 is capable of, configured to, or operable to support a means for transmitting a first random access message via the first transmission occasion and using a first resource from a first set of resources of the first transmission occasion. The communications manager 1420 is capable of, configured to, or operable to support a means for transmitting a second random access message via the second transmission occasion and using a second resource from a second set of resources of the second transmission occasion. The communications manager 1420 is capable of, configured to, or operable to support a means for monitoring for at least one of a first response message corresponding to the first random access message or a second response message corresponding to the second random access message.

Additionally, or alternatively, the communications manager 1420 may support wireless communications in accordance with examples as disclosed herein. For example, the communications manager 1420 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The communications manager 1420 is capable of, configured to, or operable to support a means for transmitting a first random access message via the first transmission occasion and using a first resource from a first set of resources of the first transmission occasion. The communications manager 1420 is capable of, configured to, or operable to support a means for monitoring for a first response message via at least a first portion of a first response window corresponding to the first random access message and the first transmission occasion. The communications manager 1420 is capable of, configured to, or operable to support a means for transmitting a second random access message via the second transmission occasion and using a second resource from a second set of resources of the second transmission occasion, where the second resource occupies different resources in time than at least the first portion of the first response window.

Additionally, or alternatively, the communications manager 1420 may support wireless communications in accordance with examples as disclosed herein. For example, the communications manager 1420 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The communications manager 1420 is capable of, configured to, or operable to support a means for transmitting a first random access message via the first transmission occasion and using a first resource from a first set of resources of the first transmission occasion. The communications manager 1420 is capable of, configured to, or operable to support a means for transmitting a second random access message via the second transmission occasion and using a second resource from a second set of resources of the second transmission occasion. The communications manager 1420 is capable of, configured to, or operable to support a means for receiving at least a first response message during a first response window corresponding to the first transmission occasion, where the first response message includes a grant of a first set of resources for transmitting a first data transmission. The communications manager 1420 is capable of, configured to, or operable to support a means for transmitting a first data message via the first set of resources according to the first response message. The communications manager 1420 is capable of, configured to, or operable to support a means for receiving a first contention resolution message corresponding to the first data message.

Additionally, or alternatively, the communications manager 1420 may support wireless communications in accordance with examples as disclosed herein. For example, the communications manager 1420 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions. The communications manager 1420 is capable of, configured to, or operable to support a means for transmitting a first instance of a random access message via the first transmission occasion and using a first resource from a first set of resources of the first transmission occasion. The communications manager 1420 is capable of, configured to, or operable to support a means for transmitting a second instance of the random access message via the second transmission occasion and using a second resource from a second set of resources of the second transmission occasion. The communications manager 1420 is capable of, configured to, or operable to support a means for receiving at least a first response message during a first response window corresponding to the first transmission occasion, where the first response message includes a contention resolution indication corresponding to the first transmission occasion.

Additionally, or alternatively, the communications manager 1420 may support wireless communications in accordance with examples as disclosed herein. For example, the communications manager 1420 is capable of, configured to, or operable to support a means for receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The communications manager 1420 is capable of, configured to, or operable to support a means for transmitting a first random access message via the first transmission occasion and using a first resource from a first set of resources of the first transmission occasion and a second random access message via the second transmission occasion and using a second resource from a second set of resources of the second transmission occasion. The communications manager 1420 is capable of, configured to, or operable to support a means for receiving at least one of a first response message including a first contention resolution indication during a first response window corresponding to the first transmission occasion, a second response message including a second contention resolution indication during a second response window corresponding to the second transmission occasion, a first contention resolution message including the first contention resolution indication, the first contention resolution message responsive to transmission of a first data message based on reception of the first response message, or a second contention resolution message including the second contention resolution indication, the second contention resolution message responsive to transmission of a second data message based on reception of the second response message, where the first response message or the first contention resolution message includes a first RNTI and where the second response message or the second contention resolution message includes a second RNTI.

By including or configuring the communications manager 1420 in accordance with examples as described herein, the device 1405 may support techniques for access procedures resulting in more efficient utilization of communication resources, improved throughput, more reliable communication, improved coordination between devices, and improved user experience.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the at least one processor 1440, the at least one memory 1430, the code 1435, or any combination thereof. For example, the code 1435 may include instructions executable by the at least one processor 1440 to cause the device 1405 to perform various aspects of enhancements for diversity schemes for contention-based transmission as described herein, or the at least one processor 1440 and the at least one memory 1430 may be otherwise configured to, individually or collectively, perform or support such operations.

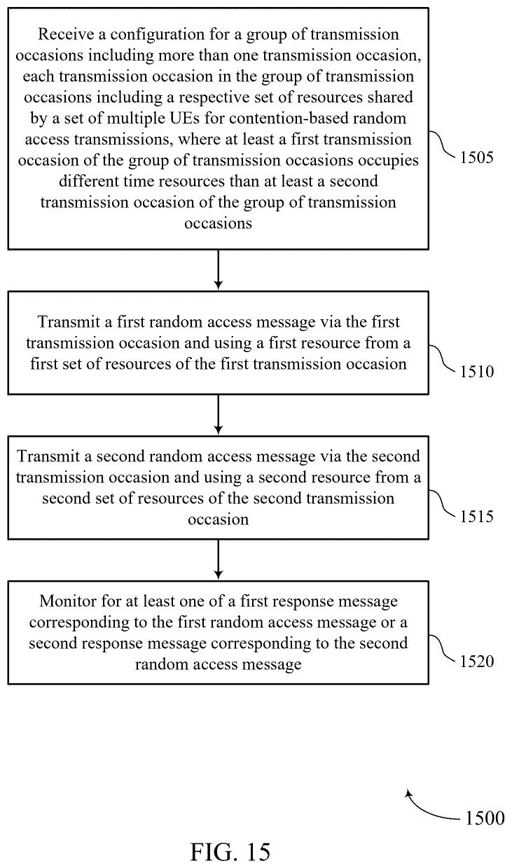

FIG. 15 shows a flowchart illustrating a method 1500 that supports enhancements for diversity schemes for contention-based transmission in accordance with one or more aspects of the present disclosure. The operations of the method 1500 may be implemented by a UE or its components as described herein. For example, the operations of the method 1500 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1505, the method may include receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions. The operations of 1505 may be performed in accordance with examples as disclosed herein. In some examples, aspects of the operations of 1505 may be performed by a TO group manager 1325 as described with reference to FIG. 13.

At 1510, the method may include transmitting a first random access message via the first transmission occasion and using a first resource from a first set of resources of the first transmission occasion. The operations of 1510 may be performed in accordance with examples as disclosed herein. In some examples, aspects of the operations of 1510 may be performed by a TO manager 1330 as described with reference to FIG. 13.

At 1515, the method may include transmitting a second random access message via the second transmission occasion and using a second resource from a second set of resources of the second transmission occasion. The operations of 1515 may be performed in accordance with examples as disclosed herein. In some examples, aspects of the operations of 1515 may be performed by a TO manager 1330 as described with reference to FIG. 13.

At 1520, the method may include monitoring for at least one of a first response message corresponding to the first random access message or a second response message corresponding to the second random access message. The operations of 1520 may be performed in accordance with examples as disclosed herein. In some examples, aspects of the operations of 1520 may be performed by a response message manager 1335 as described with reference to FIG. 13.

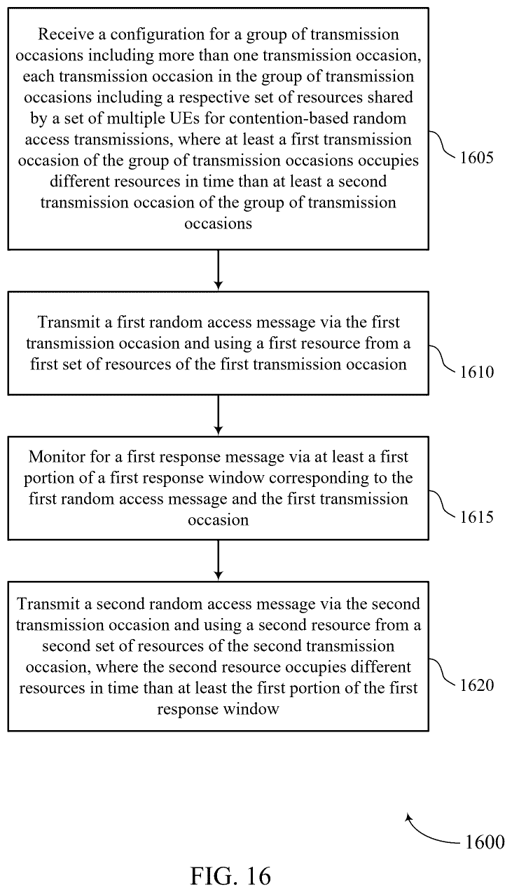

FIG. 16 shows a flowchart illustrating a method 1600 that supports enhancements for diversity schemes for contention-based transmission in accordance with one or more aspects of the present disclosure. The operations of the method 1600 may be implemented by a UE or its components as described herein. For example, the operations of the method 1600 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1605, the method may include receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The operations of 1605 may be performed in accordance with examples as disclosed herein. In some examples, aspects of the operations of 1605 may be performed by a TO group manager 1325 as described with reference to FIG. 13.

At 1610, the method may include transmitting a first random access message via the first transmission occasion and using a first resource from a first set of resources of the first transmission occasion. The operations of 1610 may be performed in accordance with examples as disclosed herein. In some examples, aspects of the operations of 1610 may be performed by a TO manager 1330 as described with reference to FIG. 13.

At 1615, the method may include monitoring for a first response message via at least a first portion of a first response window corresponding to the first random access message and the first transmission occasion. The operations of 1615 may be performed in accordance with examples as disclosed herein. In some examples, aspects of the operations of 1615 may be performed by a response message manager 1335 as described with reference to FIG. 13.

At 1620, the method may include transmitting a second random access message via the second transmission occasion and using a second resource from a second set of resources of the second transmission occasion, where the second resource occupies different resources in time than at least the first portion of the first response window. The operations of 1620 may be performed in accordance with examples as disclosed herein. In some examples, aspects of the operations of 1620 may be performed by a TO manager 1330 as described with reference to FIG. 13.

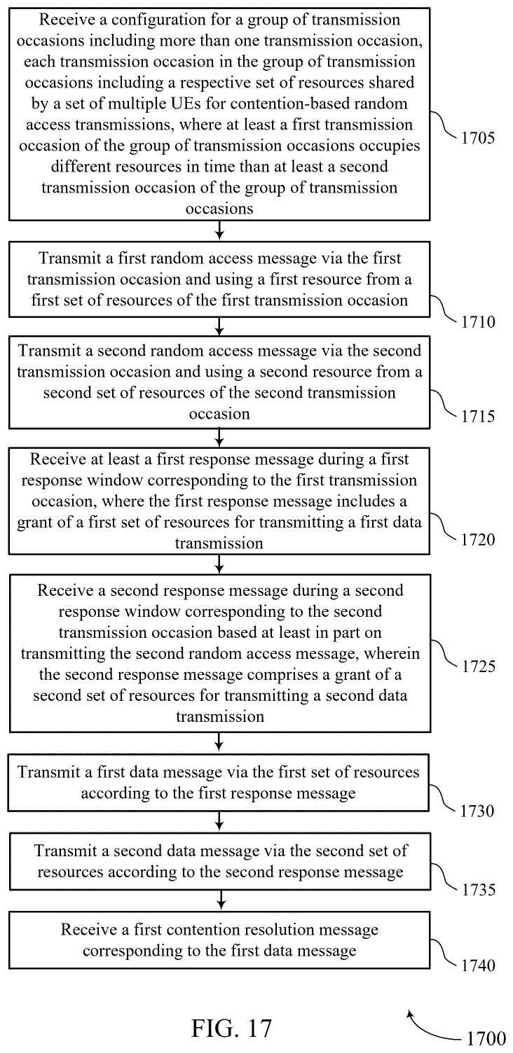

FIG. 17 shows a flowchart illustrating a method 1700 that supports enhancements for diversity schemes for contention-based transmission in accordance with one or more aspects of the present disclosure. The operations of the method 1700 may be implemented by a UE or its components as described herein. For example, the operations of the method 1700 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1705, the method may include receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The operations of 1705 may be performed in accordance with examples as disclosed herein. In some examples, aspects of the operations of 1705 may be performed by a TO group manager 1325 as described with reference to FIG. 13.

At 1710, the method may include transmitting a first random access message via the first transmission occasion and using a first resource from a first set of resources of the first transmission occasion. The operations of 1710 may be performed in accordance with examples as disclosed herein. In some examples, aspects of the operations of 1710 may be performed by a TO manager 1330 as described with reference to FIG. 13.

At 1715, the method may include transmitting a second random access message via the second transmission occasion and using a second resource from a second set of resources of the second transmission occasion. The operations of 1715 may be performed in accordance with examples as disclosed herein. In some examples, aspects of the operations of 1715 may be performed by a TO manager 1330 as described with reference to FIG. 13.

At 1720, the method may include receiving at least a first response message during a first response window corresponding to the first transmission occasion, where the first response message includes a grant of a first set of resources for transmitting a first data transmission. The operations of 1720 may be performed in accordance with examples as disclosed herein. In some examples, aspects of the operations of 1720 may be performed by a response message manager 1335 as described with reference to FIG. 13.

At 1725, the method may include receiving a second response message during a second response window corresponding to the second transmission occasion based at least in part on transmitting the second random access message, wherein the second response message comprises a grant of a second set of resources for transmitting a second data transmission. The operations of 1725 may be performed in accordance with examples as disclosed herein. In some examples, aspects of the operations of 1725 may be performed by a response message manager 1335 as described with reference to FIG. 13.

At 1730, the method may include transmitting a first data message via the first set of resources according to the first response message. The operations of 1730 may be performed in accordance with examples as disclosed herein. In some examples, aspects of the operations of 1730 may be performed by a data message manager 1340 as described with reference to FIG. 13.

At 1735, the method may include transmitting a second data message via the second set of resources according to the second response message. The operations of 1735 may be performed in accordance with examples as disclosed herein. In some examples, aspects of the operations of 1735 may be performed by a data message manager 1340 as described with reference to FIG. 13.

At 1740, the method may include receiving a first contention resolution message corresponding to the first data message. The operations of 1740 may be performed in accordance with examples as disclosed herein. In some examples, aspects of the operations of 1740 may be performed by a contention resolution manager 1345 as described with reference to FIG. 13.

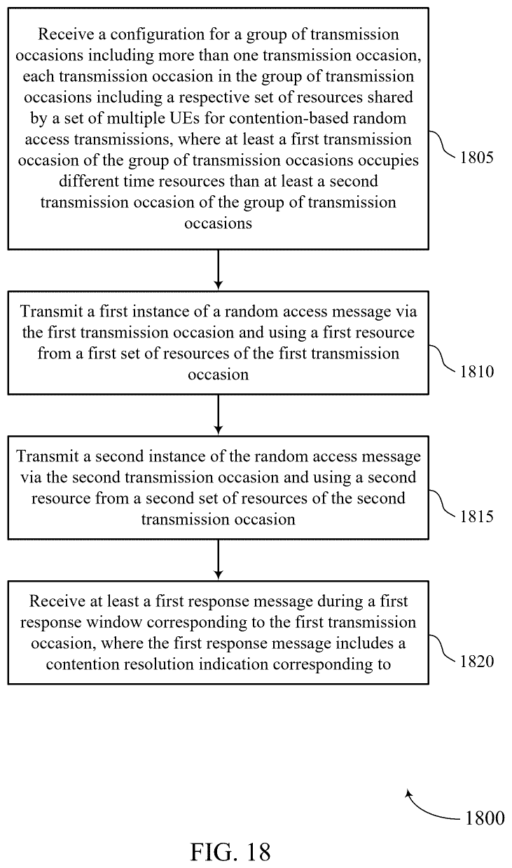

FIG. 18 shows a flowchart illustrating a method 1800 that supports enhancements for diversity schemes for contention-based transmission in accordance with one or more aspects of the present disclosure. The operations of the method 1800 may be implemented by a UE or its components as described herein. For example, the operations of the method 1800 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1805, the method may include receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different time resources than at least a second transmission occasion of the group of transmission occasions. The operations of 1805 may be performed in accordance with examples as disclosed herein. In some examples, aspects of the operations of 1805 may be performed by a TO group manager 1325 as described with reference to FIG. 13.

At 1810, the method may include transmitting a first instance of a random access message via the first transmission occasion and using a first resource from a first set of resources of the first transmission occasion. The operations of 1810 may be performed in accordance with examples as disclosed herein. In some examples, aspects of the operations of 1810 may be performed by a TO manager 1330 as described with reference to FIG. 13.

At 1815, the method may include transmitting a second instance of the random access message via the second transmission occasion and using a second resource from a second set of resources of the second transmission occasion. The operations of 1815 may be performed in accordance with examples as disclosed herein. In some examples, aspects of the operations of 1815 may be performed by a TO manager 1330 as described with reference to FIG. 13.

At 1820, the method may include receiving at least a first response message during a first response window corresponding to the first transmission occasion, where the first response message includes a contention resolution indication corresponding to the first transmission occasion. The operations of 1820 may be performed in accordance with examples as disclosed herein. In some examples, aspects of the operations of 1820 may be performed by a response message manager 1335 as described with reference to FIG. 13.

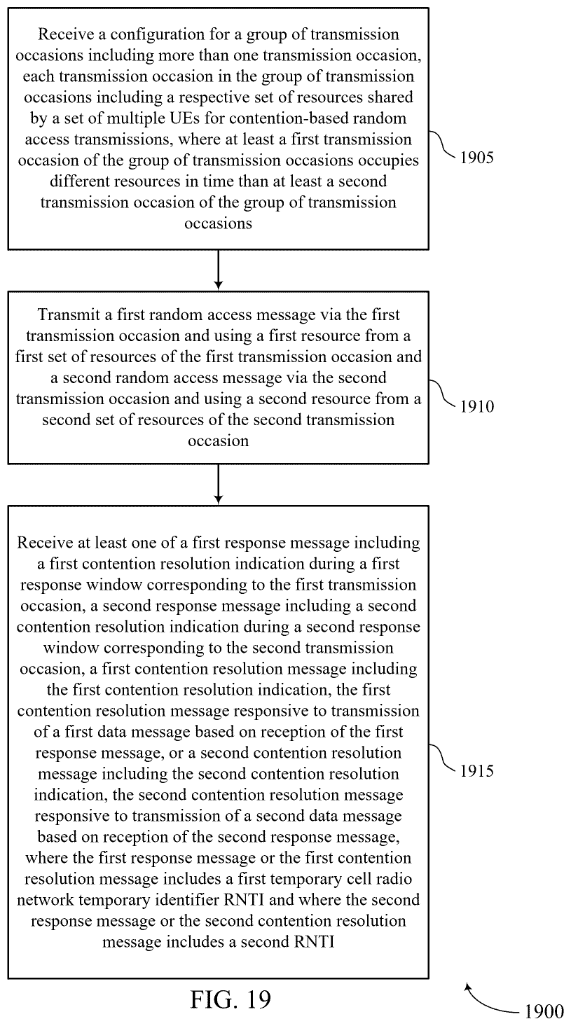

FIG. 19 shows a flowchart illustrating a method 1900 that supports enhancements for diversity schemes for contention-based transmission in accordance with one or more aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1905, the method may include receiving a configuration for a group of transmission occasions including more than one transmission occasion, each transmission occasion in the group of transmission occasions including a respective set of resources shared by a set of multiple UEs for contention-based random access transmissions, where at least a first transmission occasion of the group of transmission occasions occupies different resources in time than at least a second transmission occasion of the group of transmission occasions. The operations of 1905 may be performed in accordance with examples as disclosed herein. In some examples, aspects of the operations of 1905 may be performed by a TO group manager 1325 as described with reference to FIG. 13.

At 1910, the method may include transmitting a first random access message via the first transmission occasion and using a first resource from a first set of resources of the first transmission occasion and a second random access message via the second transmission occasion and using a second resource from a second set of resources of the second transmission occasion. The operations of 1910 may be performed in accordance with examples as disclosed herein. In some examples, aspects of the operations of 1910 may be performed by a TO manager 1330 as described with reference to FIG. 13.

At 1915, the method may include receiving at least one of a first response message including a first contention resolution indication during a first response window corresponding to the first transmission occasion, a second response message including a second contention resolution indication during a second response window corresponding to the second transmission occasion, a first contention resolution message including the first contention resolution indication, the first contention resolution message responsive to transmission of a first data message based on reception of the first response message, or a second contention resolution message including the second contention resolution indication, the second contention resolution message responsive to transmission of a second data message based on reception of the second response message, where the first response message or the first contention resolution message includes a first RNTI and where the second response message or the second contention resolution message includes a second RNTI. The operations of 1915 may be performed in accordance with examples as disclosed herein. In some examples, aspects of the operations of 1915 may be performed by a contention resolution manager 1345 as described with reference to FIG. 13.

The following provides an overview of aspects of the present disclosure:

Aspect 1: A method for wireless communications at a UE, comprising: receiving a configuration for a group of transmission occasions comprising more than one transmission occasion, each transmission occasion in the group of transmission occasions comprising a respective set of resources shared by a plurality of UEs for contention-based random access transmissions, wherein at least a first transmission occasion of the group of transmission occasions occupies different time resources than at least a second transmission occasion of the group of transmission occasions; transmitting a first random access message via the first transmission occasion and using a first resource from a first set of resources of the first transmission occasion; transmitting a second random access message via the second transmission occasion and using a second resource from a second set of resources of the second transmission occasion; and monitoring for at least one of a first response message corresponding to the first random access message or a second response message corresponding to the second random access message.

Aspect 2: The method of aspect 1, wherein none of the more than one transmission occasion in the group of transmission occasions occupy the same time resources as any other transmission occasion in the group of transmission occasions.

Aspect 3: The method of any of aspects 1 through 2, further comprising: selecting, from the group of transmission occasions, the first transmission occasion and the second transmission occasion based at least in part on the first transmission occasion occupying different resources in time than the second transmission occasion.

Aspect 4: The method of any of aspects 1 through 3, further comprising: receiving at least one of the first response message and the second response message, wherein the first response message comprises a first grant of resources for a first data message and the second response message comprises a second grant of resources for a second data message, wherein the first grant of resources and the second grant of resources occupy different resources in time.

Aspect 5: The method of any of aspects 1 through 4, wherein monitoring for at least one of the first response message and the second response message comprises: monitoring for the first response message during at least a portion of a first response window, and monitoring for the second response message during at least a portion of a second response window, wherein at least the portion of the first response window and at least the portion of the second response window occupy different resources in time.

Aspect 6: A method for wireless communications at a UE, comprising: receiving a configuration for a group of transmission occasions comprising more than one transmission occasion, each transmission occasion in the group of transmission occasions comprising a respective set of resources shared by a plurality of UEs for contention-based random access transmissions, wherein at least a first transmission occasion of the group of transmission occasions occupies different resources in time than at least a second transmission occasion of the group of transmission occasions; transmitting a first random access message via the first transmission occasion and using a first resource from a first set of resources of the first transmission occasion; monitoring for a first response message via at least a first portion of a first response window corresponding to the first random access message and the first transmission occasion; and transmitting a second random access message via the second transmission occasion and using a second resource from a second set of resources of the second transmission occasion, wherein the second resource occupies different resources in time than at least the first portion of the first response window.

Aspect 7: The method of aspect 6, wherein the first response window corresponding to the first random access message occupies different resources in time than the second transmission occasion according to the configuration of the group of transmission occasions.

Aspect 8: The method of any of aspects 6 through 7, wherein a second portion of the first response window corresponding to the first random access message occupies different resources in time than at least a portion of the second transmission occasion according to the configuration of the group of transmission occasions.

Aspect 9: The method of aspect 8, further comprising: receiving the first response message during the first portion of the first response window based at least in part on the monitoring, wherein transmission of the second random access message via the second transmission occasion occurs during the second portion of the first response window, and monitoring during the second portion of the first response window is restricted.

Aspect 10: The method of any of aspects 6 through 9, further comprising: receiving the first response message based at least in part on the monitoring, the first response message comprising a grant of a first set of resources for transmitting a first data message, wherein the first set of resources occupies different resources than any response windows corresponding to the more than one transmission occasion of the group of transmission occasions.

Aspect 11: The method of aspect 10, further comprising: transmitting the first data message via the first set of resources according to the first response message; and monitoring for a first contention resolution message corresponding to the first data message via a contention resolution window, wherein the first set of resources occupies different resources in time than any contention resolution windows associated with one or more additional transmission occasions of the more than one transmission occasion.

Aspect 12: The method of any of aspects 10 through 11, wherein a plurality of response windows corresponding to the more than one transmission occasion occupies different resources in time than any of the more than one transmission occasion.

Aspect 13: The method of any of aspects 10 through 12, wherein a plurality of contention resolution windows corresponding to the more than one transmission occasion occupy different resources in time than any of the more than one transmission occasion.

Aspect 14: A method for wireless communications at a UE, comprising: receiving a configuration for a group of transmission occasions comprising more than one transmission occasion, each transmission occasion in the group of transmission occasions comprising a respective set of resources shared by a plurality of UEs for contention-based random access transmissions, wherein at least a first transmission occasion of the group of transmission occasions occupies different resources in time than at least a second transmission occasion of the group of transmission occasions; transmitting a first random access message via the first transmission occasion and using a first resource from a first set of resources of the first transmission occasion; transmitting a second random access message via the second transmission occasion and using a second resource from a second set of resources of the second transmission occasion; receiving at least a first response message during a first response window corresponding to the first transmission occasion, wherein the first response message comprises a grant of a first set of resources for transmitting a first data transmission; receiving a second response message during a second response window corresponding to the second transmission occasion based at least in part on transmitting the second random access message, wherein the second response message comprises a grant of a second set of resources for transmitting a second data transmission; transmitting a first data message via the first set of resources according to the first response message; transmitting a second data message via the second set of resources according to the second response message; and receiving a first contention resolution message corresponding to the first data message.

Aspect 15: The method of aspect 14, further comprising: receiving a request to send a retransmission of the second data message; and refraining from sending the retransmission of the second data message based at least in part on receiving the first contention resolution message.

Aspect 16: A method for wireless communications at a UE, comprising: receiving a configuration for a group of transmission occasions comprising more than one transmission occasion, each transmission occasion in the group of transmission occasions comprising a respective set of resources shared by a plurality of UEs for contention-based random access transmissions, wherein at least a first transmission occasion of the group of transmission occasions occupies different time resources than at least a second transmission occasion of the group of transmission occasions; transmitting a first instance of a random access message via the first transmission occasion and using a first resource from a first set of resources of the first transmission occasion; transmitting a second instance of the random access message via the second transmission occasion and using a second resource from a second set of resources of the second transmission occasion; and receiving at least a first response message during a first response window corresponding to the first transmission occasion, wherein the first response message comprises a contention resolution indication corresponding to the first random access message.

Aspect 17: The method of aspect 16, further comprising: receiving a request to send a retransmission of the second instance of the random access message; and refraining from sending the retransmission of the second instance of the random access message based at least in part on receiving the first response message comprising the contention resolution indication.

Aspect 18: A method for wireless communications at a UE, comprising: receiving a configuration for a group of transmission occasions comprising more than one transmission occasion, each transmission occasion in the group of transmission occasions comprising a respective set of resources shared by a plurality of UEs for contention-based random access transmissions, wherein at least a first transmission occasion of the group of transmission occasions occupies different resources in time than at least a second transmission occasion of the group of transmission occasions; transmitting a first random access message via the first transmission occasion and using a first resource from a first set of resources of the first transmission occasion and a second random access message via the second transmission occasion and using a second resource from a second set of resources of the second transmission occasion; and receiving at least one of a first response message comprising a first contention resolution indication during a first response window corresponding to the first transmission occasion, a second response message comprising a second contention resolution indication during a second response window corresponding to the second transmission occasion, a first contention resolution message comprising the first contention resolution indication, the first contention resolution message responsive to transmission of a first data message based at least in part on reception of the first response message, or a second contention resolution message comprising the second contention resolution indication, the second contention resolution message responsive to transmission of a second data message based at least in part on reception of the second response message, wherein the first response message or the first contention resolution message is associated with a first radio network temporary identifier (RNTI) and wherein the second response message or the second contention resolution message is associated with a second RNTI.

Aspect 19: The method of aspect 18, further comprising: transmitting an acknowledgement message corresponding to the first contention resolution indication.

Aspect 20: The method of aspect 19, further comprising: obtaining a new C-RNTI indicated in the first contention resolution message or the first response message; and performing wireless communications with a network entity according to the new C-RNTI.

Aspect 21: The method of any of aspects 19 through 20, further comprising: promoting the first RNTI to a C-RNTI based at least in part on receiving the first contention resolution message or the first response message; and performing wireless communications with a network entity according to the non-temporary C-RNTI.

Aspect 22: The method of any of aspects 19 through 21, wherein the acknowledgement message comprises an indication of one or more copies of the first random access message, one or more copies of the first data message, or a combination thereof, corresponding to one or more additional transmission occasions of the more than one transmission occasion of the group of transmission occasions.

Aspect 23: The method of any of aspects 19 through 22, wherein the UE ceases monitoring for the second response message or monitoring for the second contention resolution message upon receiving the first response message or upon receiving the first contention resolution message.

Aspect 24: The method of any of aspects 18 through 23, further comprising: receiving the first contention resolution indication; receiving the second contention resolution indication; selecting the first contention resolution indication; and transmitting a first acknowledgement message corresponding to the first contention resolution indication based at least in part on the selecting.

Aspect 25: The method of aspect 24, further comprising: refraining from transmitting a second acknowledgement message corresponding to the second contention resolution indication based at least in part on the selecting.

Aspect 26: The method of any of aspects 24 through 25, wherein the selecting comprises a random selection of the first contention resolution indication from a plurality of contention resolution.

Aspect 27: The method of any of aspects 24 through 26, wherein selecting the first contention resolution indication is based at least in part on the first RNTI having a lower value than the second RNTI, a timing of the first data message and the second data message, an order in time of the more than one transmission occasion of the group of transmission occasions, a preconfigured rule, one or more index values corresponding to the more than one transmission occasion, an instruction from a network entity, or any combination thereof.

Aspect 28: The method of any of aspects 24 through 27, further comprising: selecting a first new C-RNTI indicated in the first contention resolution message or the first response message based at least in part on selecting the first contention resolution indication, wherein the second contention resolution message or the second response message indicates a second new C-RNTI; updating the first RNTI to a first new C-RNTI indicated in the first contention resolution message or the first response message; and communicating with a network entity according to a first updated C-RNTI, wherein the first contention resolution message or the first response message includes the first updated C-RNTI, and the second contention resolution message or the second response message includes a second updated C-RNTI.

Aspect 29: The method of any of aspects 24 through 28, further comprising: promoting the first RNTI to a non-temporary C-RNTI based at least in part on the selecting; and performing wireless communications with a network entity according to the non-temporary C-RNTI.

Aspect 30: A UE for wireless communications, comprising one or more memories storing processor-executable code, and one or more processors coupled with the one or more memories and individually or collectively operable to execute the code to cause the UE to perform a method of any of aspects 1 through 5.

Aspect 31: A UE for wireless communications, comprising at least one means for performing a method of any of aspects 1 through 5.

Aspect 32: A non-transitory computer-readable medium storing code for wireless communications, the code comprising instructions executable by one or more processors to perform a method of any of aspects 1 through 5.

Aspect 33: A UE for wireless communications, comprising one or more memories storing processor-executable code, and one or more processors coupled with the one or more memories and individually or collectively operable to execute the code to cause the UE to perform a method of any of aspects 6 through 13.

Aspect 34: A UE for wireless communications, comprising at least one means for performing a method of any of aspects 6 through 13.

Aspect 35: A non-transitory computer-readable medium storing code for wireless communications, the code comprising instructions executable by one or more processors to perform a method of any of aspects 6 through 13.

Aspect 36: A UE for wireless communications, comprising one or more memories storing processor-executable code, and one or more processors coupled with the one or more memories and individually or collectively operable to execute the code to cause the UE to perform a method of any of aspects 14 through 15.

Aspect 37: A UE for wireless communications, comprising at least one means for performing a method of any of aspects 14 through 15.

Aspect 38: A non-transitory computer-readable medium storing code for wireless communications, the code comprising instructions executable by one or more processors to perform a method of any of aspects 14 through 15.

Aspect 39: A UE for wireless communications, comprising one or more memories storing processor-executable code, and one or more processors coupled with the one or more memories and individually or collectively operable to execute the code to cause the UE to perform a method of any of aspects 16 through 17.

Aspect 40: A UE for wireless communications, comprising at least one means for performing a method of any of aspects 16 through 17.

Aspect 41: A non-transitory computer-readable medium storing code for wireless communications, the code comprising instructions executable by one or more processors to perform a method of any of aspects 16 through 17.

Aspect 42: A UE for wireless communications, comprising one or more memories storing processor-executable code, and one or more processors coupled with the one or more memories and individually or collectively operable to execute the code to cause the UE to perform a method of any of aspects 18 through 29.

Aspect 43: A UE for wireless communications, comprising at least one means for performing a method of any of aspects 18 through 29.

Aspect 44: A non-transitory computer-readable medium storing code for wireless communications, the code comprising instructions executable by one or more processors to perform a method of any of aspects 18 through 29.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a configuration for a group of transmission occasions comprising more than one transmission occasion, each transmission occasion in the group of transmission occasions comprising a respective set of resources shared by a plurality of UEs for contention-based random access transmissions, wherein at least a first transmission occasion of the group of transmission occasions occupies different time resources than at least a second transmission occasion of the group of transmission occasions;
transmit a first random access message via the first transmission occasion and using a first resource from a first set of resources of the first transmission occasion;
transmit a second random access message via the second transmission occasion and using a second resource from a second set of resources of the second transmission occasion; and
monitor for at least one of a first response message corresponding to the first random access message or a second response message corresponding to the second random access message.

2. The UE of claim 1, wherein none of the more than one transmission occasion in the group of transmission occasions occupy the same time resources as any other transmission occasion in the group of transmission occasions.

3. The UE of claim 1, wherein the one or more processors are individually or collectively further operable to execute the code to cause the UE to:
select, from the group of transmission occasions, the first transmission occasion and the second transmission occasion based at least in part on the first transmission occasion occupying different resources in time than the second transmission occasion.

4. The UE of claim 1, wherein the one or more processors are individually or collectively further operable to execute the code to cause the UE to:
receive at least one of the first response message and the second response message, wherein the first response message comprises a first grant of resources for a first data message and the second response message comprises a second grant of resources for a second data message, wherein the first grant of resources and the second grant of resources occupy different resources in time.

5. The UE of claim 1, wherein, to monitor for at least one of the first response message and the second response message, the one or more processors are individually or collectively operable to execute the code to cause the UE to:
monitor for the first response message during at least a portion of a first response window, and monitoring for the second response message during at least a portion of a second response window, wherein at least the portion of the first response window and at least the portion of the second response window occupy different resources in time.

6. A user equipment (UE), comprising:
one or more memories storing processor-executable code; and
one or more processors coupled with the one or more memories and individually or collectively operable to execute the code to cause the UE to:
receive a configuration for a group of transmission occasions comprising more than one transmission occasion, each transmission occasion in the group of transmission occasions comprising a respective set of resources shared by a plurality of UEs for contention-based random access transmissions, wherein at least a first transmission occasion of the group of transmission occasions occupies different resources in time than at least a second transmission occasion of the group of transmission occasions;
transmit a first random access message via the first transmission occasion and using a first resource from a first set of resources of the first transmission occasion;
monitor for a first response message via at least a first portion of a first response window corresponding to the first random access message and the first transmission occasion; and
transmit a second random access message via the second transmission occasion and using a second resource from a second set of resources of the second transmission occasion, wherein the second resource occupies different resources in time than at least the first portion of the first response window.

7. The UE of claim 6, wherein the first response window corresponding to the first random access message occupies different resources in time than the second transmission occasion according to the configuration of the group of transmission occasions.

8. The UE of claim 6, wherein a second portion of the first response window corresponding to the first random access message occupies different resources in time than at least a portion of the second transmission occasion according to the configuration of the group of transmission occasions.

9. The UE of claim 8, wherein the one or more processors are individually or collectively further operable to execute the code to cause the UE to:
receive the first response message during the first portion of the first response window based at least in part on the monitoring, wherein transmission of the second random access message via the second transmission occasion occurs during the second portion of the first response window, and monitoring during the second portion of the first response window is restricted.

10. The UE of claim 6, wherein the one or more processors are individually or collectively further operable to execute the code to cause the UE to:
receive the first response message based at least in part on the monitoring, the first response message comprising a grant of a first set of resources for transmitting a first data message, wherein the first set of resources occupies different resources than any response windows corresponding to the more than one transmission occasion of the group of transmission occasions.

11. The UE of claim 10, wherein the one or more processors are individually or collectively further operable to execute the code to cause the UE to:
transmit the first data message via the first set of resources according to the first response message; and
monitor for a first contention resolution message corresponding to the first data message via a contention resolution window, wherein the first set of resources occupies different resources in time than any contention resolution windows associated with one or more additional transmission occasions of the more than one transmission occasion.

12. The UE of claim 10, wherein a plurality of response windows corresponding to the more than one transmission occasion occupies different resources in time than any of the more than one transmission occasion.

13. The UE of claim 10, wherein a plurality of contention resolution windows corresponding to the more than one transmission occasion occupy different resources in time than any of the more than one transmission occasion.

14. A user equipment (UE), comprising:
one or more memories storing processor-executable code; and
one or more processors coupled with the one or more memories and individually or collectively operable to execute the code to cause the UE to:
receive a configuration for a group of transmission occasions comprising more than one transmission occasion, each transmission occasion in the group of transmission occasions comprising a respective set of resources shared by a plurality of UEs for contention-based random access transmissions, wherein at least a first transmission occasion of the group of transmission occasions occupies different resources in time than at least a second transmission occasion of the group of transmission occasions;
transmit a first random access message via the first transmission occasion and using a first resource from a first set of resources of the first transmission occasion;
transmit a second random access message or a second instance of the first random access message via the second transmission occasion and using a second resource from a second set of resources of the second transmission occasion; and
receive at least a first response message during a first response window corresponding to the first transmission occasion, wherein the first response message comprises a grant of a first set of resources for transmitting a first data transmission or a contention resolution indication corresponding to the first random access message.

15. The UE of claim 14, wherein the one or more processors are individually or collectively further operable to execute the code to cause the UE to:
receive a second response message during a second response window corresponding to the second transmission occasion based at least in part on transmitting the second random access message, wherein the second response message comprises a grant of a second set of resources for transmitting a second data transmission;
transmit a first data message via the first set of resources according to the first response message;
transmit a second data message via the second set of resources according to the second response message; and
receive a first contention resolution message corresponding to the first data message.

16. The UE of claim 15, wherein the one or more processors are individually or collectively further operable to execute the code to cause the UE to:
receive a request to send a retransmission of the second data message; and
refrain from sending the retransmission of the second data message based at least in part on receiving the first contention resolution message.

17. The UE of claim 14, wherein the one or more processors are individually or collectively further operable to execute the code to cause the UE to:
receive a request to send a retransmission of the second instance of the second random access message; and
refrain from sending the retransmission of the second instance of the second random access message based at least in part on receiving the first response message comprising the contention resolution indication.

18. The UE of claim 14, wherein the one or more processors are individually or collectively further operable to execute the code to cause the UE to:
obtain a new cell radio network temporary identifier (C-RNTI) indicated in a first contention resolution message or the first response message; and
perform wireless communications with a network entity according to the new C-RNTI.

19. The UE of claim 14, wherein the one or more processors are individually or collectively further operable to execute the code to cause the UE to:
promote a first radio network temporary identifier RNTI to a cell radio network temporary identifier (C-RNTI) based at least in part on receiving a first contention resolution message or the first response message; and
perform wireless communications with a network entity according to the C-RNTI.

20. The UE of claim 19, further comprising:
transmitting an acknowledgement message corresponding to the first contention resolution message, wherein the acknowledgement message comprises an indication of one or more copies of the first random access message, one or more copies of the first data message, or a combination thereof, corresponding to one or more additional transmission occasions of the more than one transmission occasion of the group of transmission occasions.
